(19) United States
(12) Patent Application Publication
(10) Pub. No.: US 2018/0365578 A1
(43) Pub. Date: Dec. 20, 2018

(54) COMPUTER SYSTEM DECISION ENGINE

(71) Applicant: Fair IP, LLC, Santa Monica, CA (US)

(72) Inventors: Ryan James Naughton, Santa Monica, CA (US); Serge Madenian, Northridge, CA (US)

(21) Appl. No.: 16/011,617

(22) Filed: Jun. 18, 2018

Related U.S. Application Data
(60) Provisional application No. 62/520,597, filed on Jun. 16, 2017.

(51) Int. Cl. G06N 5/04; G06F 17/30; G06N 99/00

(52) U.S. Cl. CPC G06N 5/045; G06N 99/005; G06F 17/30961

(57) ABSTRACT

A decision system comprising a data store storing a set of decisions, a processor, a non-transitory computer readable storage medium storing computer code executable by the processor to receive, from a first service in a runtime environment, a decision request that references a decision from the set of decisions and an decision input for the decision request. The decision system generates a decision tree data structure from the set of decisions, the tree data structure including a plurality of nodes that represent decisions in the set of decisions, data sources referenced by the decisions, and decision rules that specify conditions on data. The tree data structure further represents relationships between the decisions, data sources and decision rules. The decision system uses the decision tree data structure to control fetching of data source instances and to applying decision rules.

### RELATED APPLICATIONS

This application claims the benefit of priority of United States Provisional Patent Application No. 62/520,597 entitled “Computer System Decision Engine,” filed Jun. 16, 2017, which is hereby fully incorporated by reference herein in its entirety.

### BACKGROUND

Some network sites employ computer-based decision systems to make decisions that affect the content provided to users via a web page or web application. A decision system may employ a software system, referred to as a rules engine, that executes rules in a runtime production environment to approve/disapprove users for accounts, determine which products/services to offer to users and make other decisions that affect the content provided to users. The rules may be based on regulations, company policies and other rules sources.

Typically, the rules applied by a rules engine are inextricably linked to rules engine code. Even in systems that provide some mechanism to easily change constant or variable values of particular rules (e.g., through a UI), other aspects of the rules are hard coded into the rules engine. Defining and changing rules in such systems requires deep programming knowledge to reprogram the rules engine.

### SUMMARY

One embodiment includes a decision system comprising a data store storing a set of decisions ingestible by a decision engine, a processor and a non-transitory computer readable storage medium storing computer code executable by the processor. The decisions in the set of decisions can be defined independently from the computer code. The computer code can be executable to receive, from a first service in the runtime environment, a decision request that references a decision from the set of decisions and a decision input for the decision request. The code is further executable to generate a decision tree data structure from the set of decisions. According to one embodiment the decision tree data structure comprises a directed acyclic graph.

The tree data structure includes plurality of nodes that represent decisions in the set of decisions, data sources referenced by the decisions, and decision rules that specify conditions on data. The tree data structure further represents relationships between the decisions, data sources and decision rules. The decision tree data structure may comprise a plurality of paths from a decision node representing the decision to leaf nodes of the decision tree data structure. Each path may include at least one failure code.

The computer code can be executable to use the decision tree data structure to control fetching of instances of the data sources and applying decision rules. The code can be executable to traverse the decision tree data structure to identify data sources to fetch and decision rules to apply. The code is further executable to request instances of the identified data sources from a second service in the runtime environment. According to one embodiment, the decision system may pre-fetch an instance of a data source for a subdecision based on a reference to the data source that is higher in the decision tree data structure than a node that represents the subdecision.

The code can be further executable to determine if a set of data meets a set of conditions specified in the identified decision rules. The set of data to which the conditions are applied can include data from an instance of an identified data source. In some embodiments, the data sources may define sets of data from remote information provider systems. Thus decisions can incorporate and rules can be applied to a data from a variety of sources, including data from online services. The set of data to which the conditions are applied may also include data from the decision input or a prediction or other data. Based on a determination that the set of data meets the set of conditions, the decision system can return, to the first service, a decision result that includes an indication that the decision input passed the referenced decision. Based on a determination that the set of data does not meet the set of conditions, the decision system can return, to the first service, a decision result that comprises a failure code.

The computer code may be further executable to cross reference arguments required for fetching an instance of a data source with a first set of decision input attributes. Based on a determination that decision the first set of decision input attributes do not contain the required arguments, the decision system can request additional decision input attributes from the decision requestor. According to one embodiment, the decision tree data structure comprises a node that represents the data source and includes an attribute schema defining the arguments required to fetch the instance of the data source. Thus, according to one embodiment, the required attributes may be determined from the decision tree data structure.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

FIG. 1 is a diagrammatic representation of one embodiment of a decision system.

FIG. 2 is a diagrammatic representation of another embodiment of a decision system.

FIG. 3 is a diagrammatic representation of yet another embodiment of a decision system.

FIG. 4 is a diagrammatic representation of one embodiment of a set of decision information.

FIG. 5 is a diagrammatic representation of an example decision according to one embodiment of a rules syntax.

FIG. 6 is a diagrammatic representation of an example decision according to one embodiment of a rules syntax.

FIG. 7 is a diagrammatic representation of another example decision according to one embodiment of a rules syntax.

FIG. 8 is a diagrammatic representation of another example decision according to one embodiment of a rules syntax.

FIG. 9 is a diagrammatic representation of another example decision according to one embodiment of a rules syntax.

FIG. 10 is a diagrammatic representation of another example decision according to one embodiment of a rules syntax.

FIG. 11 is a diagrammatic representation of an example decision according to another embodiment of a rules syntax.

FIG. 12A is a diagrammatic representation of a first portion of another example decision according to one embodiment of a rules syntax.

FIG. 12B is a diagrammatic representation of a second portion of an example decision according to one embodiment of a rules syntax.

FIG. 13 is a diagrammatic representation of one embodiment of a data source argument schema.

FIG. 14 is a diagrammatic representation of one embodiment of a decision tree.

FIG. 15 is a diagrammatic representation of another embodiment of a decision tree.

FIG. 16 is a diagrammatic representation of one embodiment of a distributed computing environment.

### DESCRIPTION

The disclosure and various features and advantageous details thereof are explained more fully with reference to the exemplary, and therefore non-limiting, embodiments illustrated in the accompanying drawings and detailed in the following description and appendices/attachments. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Embodiments of the present disclosure provide a decision system with simplified rules management. According to an embodiment, the decision system is a computer system that comprises a decision engine for executing decisions in a runtime environment, where the decisions include rules to be enforced by the computer system in evaluating a set of data. The rules can include, for example, business rules enforced by the computer system. These decisions may be stored in a data store rather than in the decision engine code. Consequently, decision rules can be added, edited and removed without code changes. Moreover, the decision engine may support a simplified rules syntax so that non-programmers can define and edit the decisions.

Decisions may incorporate a variety of rules, data sources and predictions. According to one embodiment, the decision engine is configured to load a decision and parse the decision to create a directed acyclic graph model representing the relationships between decisions, rules and data from data providers. Decisions may be organized, for example, in a decision tree that defines the sources of data, variables and models to be loaded for each level of the tree. In response to a request for a decision, the decision service traverses the tree beginning at the node for the requested decision and including the sub-decisions, through n number of levels of decisions. The decision engine walks the tree to determine data required for the decision and pre-fetches or not data for decisions further in the decision tree based on configuration. For example, according to one embodiment, the decision engine can be configured to pull data sets for a requested decision and subdecisions of that decision responsive to the request for the decision. In another embodiment, the decision service can be configured to wait to fetch data until executing a decision or requesting a prediction that uses the data.

The decision tree can be used to control fetching of data. In particular, the decision engine can be configured to fetch data based on where the data is referenced in the decision tree data structure. For example, decisions can be defined to cause the decision system to wait to pull certain data until other decisions in the decision tree have been passed. As another example, decisions may be defined to cause the decision engine to pull certain data early if it is known that the data takes a significant amount of time to collect. The decision engine may also support explicit scheduling statements that control when data is pulled. The decision system thus allows flexible configuration of fetching data from data providers.

For a computer system that incorporates a decision engine to make decisions on large amounts of data from multiple data vendors, this flexibility to control data fetching through the decisions allows the decision engine to be optimized for a particular set of decisions and information providers. As the decisions are updated or changed, the order of data fetching can be changed without changing the decision engine code. Furthermore, new decisions, data sources, rules and predictions can be incorporated without changing the decision engine code.

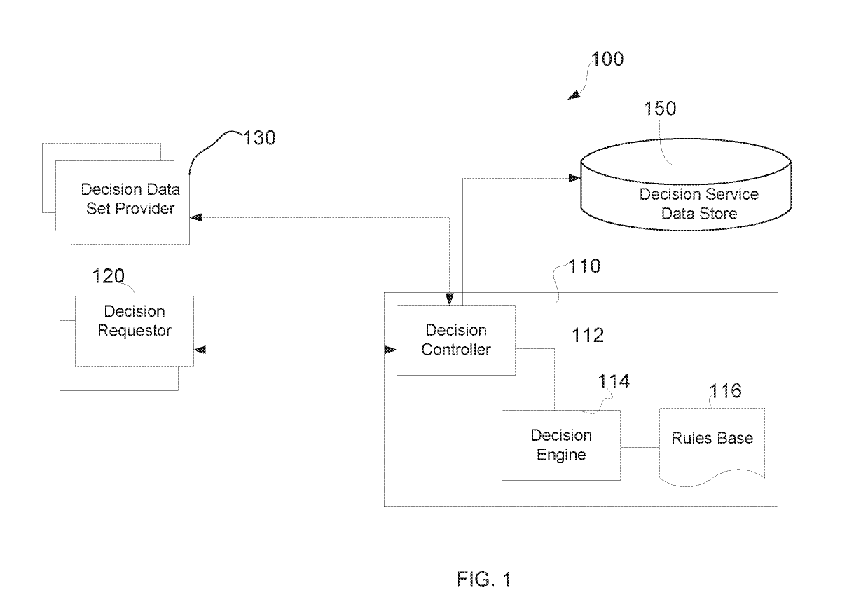

FIG. 1 is a diagrammatic representation of one embodiment of a decision system 100. Decision system 100 comprises one or more computer systems with central processing units executing instructions embodied on one or more computer readable media where the instructions are configured to perform at least some of the functionality associated with embodiments of the present invention. The instructions are executable to provide a software architecture comprising one or more components. In the embodiment illustrated, the software architecture comprises decision service 110, decision requestors 120 and decision data providers 130. Decision service 110, decision requestors 120 and decision data providers 130 may include interfaces, such as APIs or other interfaces, so that other services can send calls and data to and receive data from that component.

The components may utilize various data stores operable to store obtained data, processed data determined during operation, rules/models that may be applied to obtained data or processed data to generate further processed data and other information used by the services. A data store may comprise a database, file system, combination thereof or other data store. The various services may utilize independent data stores such the data store of each service is not accessible by the other services. For example, decision service 110 may use decision service data store 150. Decision service 110 may also include a decision base 116 that stores decisions. Decision base 116 may be part of data store 150 or another data store.

A decision requestor 120 is a service configured to request a decision from decision service 110. In one embodiment, the decision requestor 120 is configured to request decision from decision service 110 responsive to input from client computers. The decision results can be used by the decision requestor 120 or other service to take a responsive action, such as generate or select content to return to a client computer, approve/disapprove a user action or take another action.

Decision service 110 includes a decision controller 112 and decision engine 114. Decision controller 112, according to one embodiment, is the main application layer of decision service 110 that routes calls between services and is responsible for logging actions. In particular, decision controller 112 is configured to receive requests for decisions from decision requestors 120 and route the decision requests to decision engine 114, route decision results to the decision requestor, route requests for data from decision engine 114 to data providers 130 and route requested data to decision engine 114.

Decision engine 114 is a rules-based software system that provides a service that, in a runtime environment, executes decisions from a decision base 116 on data to generate a decision output. Executing a decision can include applying a set of decision rules to the data. Decisions may be based on a decision abstract class defining processes for processing rules in the decision and gathering data and attributes. Particular decisions may be implemented as specific classes. Particular decision classes may define methods for processing rules in the decision and accessing data to which the rules apply.

Each decision in decision base 116 may have an associated type (e.g., indicated as “kind” or “type” in example embodiments below) that indicates the type of decision being implemented. The decision type can be used by other services (e.g., decision requestor 120) to request a decision or by other decisions to reference that decision (e.g., to create a tree of decisions).

Thus, a decision requestor 120 can generate a decision request to decision service 110 referencing a decision type from decision base 116. The decision requestor 120 also provides a decision input for the decision request. The decision input comprises a set of data for which the decision is being requested. For example, in a vehicle data system such as described in U.S. patent application Ser. No. 15/873,536 and PCT Application US2018/017082, each entitled “Data Processing System and Method for Transaction Facilitation for Inventory Items,” and filed Jan. 17, 2018, the entire contents of which are incorporated herein by reference for all purposes, the decision input may be some minimum set of information needed to approve a user and/or a particular transaction. Certain information, such as personally identifiable information (PII), may be encrypted and/or tokenized when passed to decision service 110.

A decision specifies rules on how to interpret data to reach a decision result. A decision may contain rules that apply to data from the decision input, data from data providers 130, the results of sub-decisions, or other data. In general, decision engine 114 executes the decision rules to determine if a set of data meets conditions specified in the decision rules for the decision type and generates an output based on the application of conditions to the data. The data to which the conditions are applied may or may not include the decision inputs.

A decision may reference data from other services or components to which the rules apply, including data from services or components external to the decision engine (“external decision data providers”). For example, a system in which decision service 110 is implemented may include various data providers 130 that can be called to provide data to other services and decisions may reference data from data providers 130. When processing a decision that references data from a data provider 130, decision engine 114 can gather the data referenced in the decision and apply the decision rules to the data.

A decision may reference a data source. A data source specifies a defined set of data from one or more databases or information provider systems (e.g., external systems, such as third party systems) that can be passed to other services. For example, a data source may define report containing data gathered from one or more information provider systems. The decision service can collect the data for an instance of the data source from data provider 130 and use the data from the data source instance in executing decision rules. Decision service 110 may cache a data source instance so that, within a specified time window, it can respond to requests for the data source with cached data rather than fetching the data again from the information provider system. In some cases, the decision may specify a ‘force’ fetch of a data source, such that decision service 110 fetches a fresh data source instance from data source provider 130 (e.g., from the third party vendor) rather than using a cached report instance.

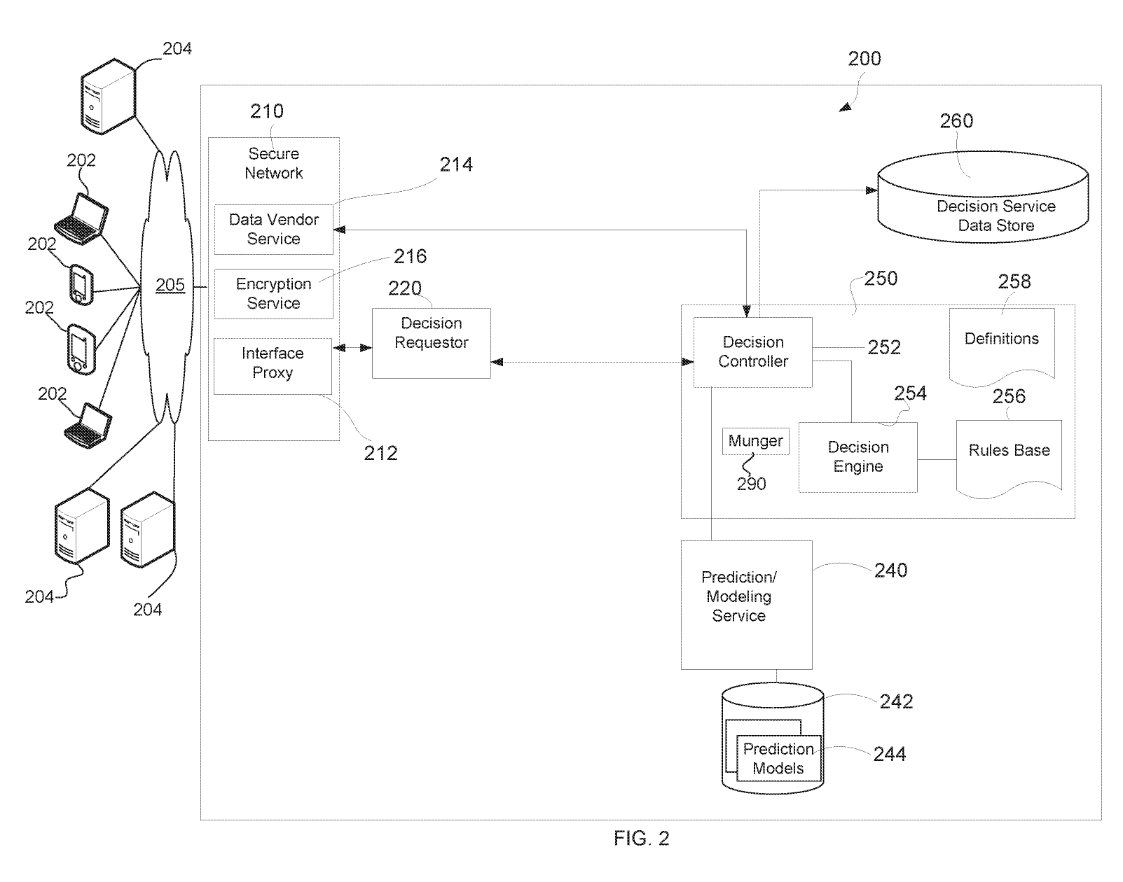

According to one embodiment, decision service 110 defines and manages data sources, data source versions, data source arguments, and data source records. Decision service 110 can maintain a definition of the arguments needed to collect data for instances of data sources. In such an embodiment, a data provider 130 may comprise a service that includes APIs for information provider systems. The data provider 130 can be configured to receive, from decision service 110, the arguments necessary to collect an instance of a data source, interface with the information provider system to collect data for the instance of the data source and return the instance of the data source to decision service 110. In the embodiment of FIG. 2, for example, data vendor service 214 acts as a data provider 130 that is used to collect instances of data sources.

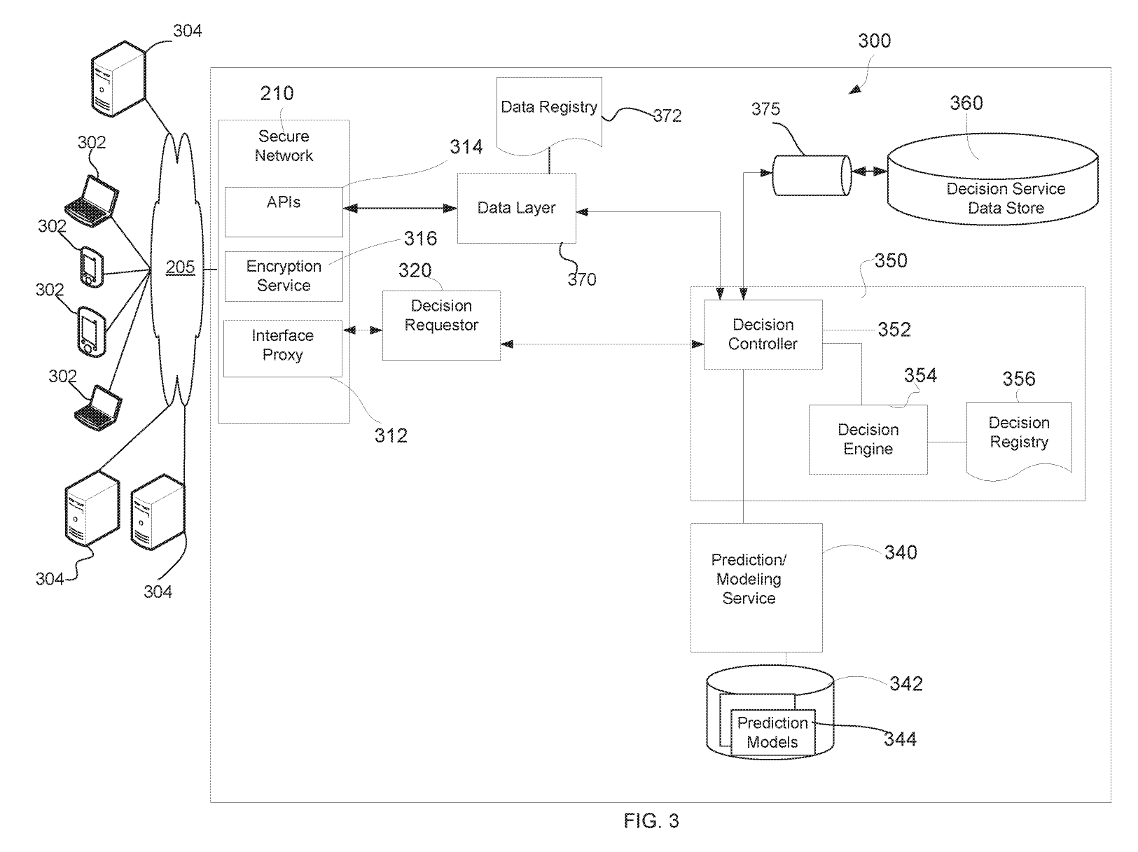

In another embodiment, a data provider 130 defines and manages data sources, data source versions, data source arguments, and data source records. In the embodiment of FIG. 3, for example, data layer 370 defines and manages data sources, data source versions, data source arguments, and data source records.

A decision may also reference a prediction from a service that applies prediction models (e.g., user defined prediction rules or machine learning models) to generate prediction results. In such an embodiment, decisions may reference predictions exposed by the prediction data provider 130. If a decision references a prediction, decision engine 114 can generate a prediction request to the data provider 130 and receive the prediction result.

Decisions may reference processes that can be called to perform operations on data and return results. For example, within the decision engine 114 a data munger may combine or transforms data sources or prediction results (source from data provider 130) into related data to be used in the decision rules.

On receiving a request for a decision, decision controller 112 passes the decision request along with relevant decision input data to decision engine 114 and passes the decision result generated by decision engine 114 back to the requesting service (including a unique decision identifier).

According to one embodiment, when decision engine 114 receives a request for a decision, decision engine 114 confirms what data is required to retrieve data from data providers 130 needed to execute the decision prior to executing a call to data provider 130. For example, if a decision references a “Report A version 1” data source, and a social security number is required to fetch that report, decision engine 114 can cross reference the required arguments for fetching an instance of said data source with the arguments provided in the decision input from the decision requestor 120 and assess whether the dependencies have been met, resulting in a fetching of an instance of the data source, or not, resulting in decision service 110 responding to the decision requestor 120 with what further arguments are needed.

Moreover, when the decision engine 114 receives a request for a decision, the decision engine 114 may not know what data is required for a prediction referenced by the decision. The decision engine can call over to the data provider 130 with an indication of the prediction and the data provider informs the decision engine 114 of the data needed for the prediction. For example, if decision engine 114 makes a call to the data provider 130 for an “Income Prediction version 1”, the data provider 130 can inform decision engine 114 of the data sources or other data needed to make the prediction. The decision engine 114 can then determine if it has the data necessary to request the data source instance required by the prediction.

In response to a complete set of arguments, i) decision engine 114 passes the arguments (which may be encrypted or tokenized) to data provider 130, ii) the data provider 130 collects or generates the requested data and iii) the data provider provides the requested data to decision engine. Continuing with the previous example, i) decision engine 114 passes the arguments needed to collect an instance of Report A version 1 to the data provider 130 that provides instances of Report A version 1, ii) the data provider 130 collects the data for the Report A version 1 instance from an information provider system via the API for the information provider system and iii) the data provider 130 returns the Report A version 1 instance to decision engine 114.

Thus, based on the decision type and decision input attributes for the decision that decision engine 114 is being requested to make, decision engine 114 can access the appropriate rules (e.g., from decision service data store 150), retrieve the required data (e.g., data sources and/or prediction scores, munged data or other data) process the decision rules to generate a decision result and return the decision result to the requesting service. The decision result may include the ID of the decision and metadata about the decision including, for example, an indication of whether the decision result was a pass or a fail, prediction scores generated when making the decision, decline codes indicating why the decision failed or other decision metadata.

Decision controller 112 returns the decision result to the calling service (e.g., decision requestor 120). Decision controller 112 may also store data associated with the decision in decision service data store 150 (such as, but not limited to, decision type, decision inputs, model identifier, prediction inputs, prediction scores, data source instances, decision result metadata).

Decision systems according to the present disclosure can be implemented in a variety of configurations. FIG. 2, for example, is a diagrammatic representation of one embodiment of a network topology that includes a decision system 200 coupled through network 205 to client computing devices 202 (e.g. computer systems, personal data assistants, smart phones or other client computing devices) and one or more information provider systems 204. Network 205 may be, for example, a wireless or wireline communication network such as the Internet or wide area network (WAN), publicly switched telephone network (PTSN) or any other type of communication link.

Client computing devices 202 may comprise one or more computer systems with central processing units executing instructions embodied on one or more computer readable media where the instructions are configured to interface with decision system 200. A client computing device 202 may comprise, for example, a desktop, laptop, smart phone or other device. A client computing device may run a client application, such as an application specifically configured to interface with decision system 200 to generate application pages for display to a user, a web browser or other client application.

Information provider systems 204 are systems of entities that provide information used in processing decisions. For example, in an embodiment in which decision system 200 is configured to determine if a user qualifies for financing for a vehicle, information provider systems 204 may include computer systems controlled by credit bureaus, fraud and ID vendors, data vendors or financial institutions. Information provider systems 204 may comprise any number of other various sources accessible over network 205, which may provide other types of desired data.

Decision system 200 comprises one or more computer systems with central processing units executing instructions embodied on one or more computer readable media where the instructions are configured to perform at least some of the functionality associated with embodiments of the present invention. The instructions are executable to provide a software architecture comprising one or more components. In the embodiment illustrated, the software architecture comprises secure network services 210, decision requestor 220, data modelling and prediction service 240, decision service 250 and data munger 290. Each of decision requestor 220, decision service 250, data modeling and prediction service 240 and secure network services 210 may include interfaces, such as APIs or other interface, so that other services can send calls and data to and receive data from that service.

The services may utilize various data stores operable to store obtained data, processed data determined during operation, rules/models that may be applied to obtained data or processed data to generate further processed data and other information used by the services. For example, decision requestor 220 may store data used for decision inputs in a data store, data modeling and prediction service 240 stores prediction models 244 in a model store 242, decision service 250 stores data in data store 260 and decision base 256, which may be part of data store 260. A data store may comprise a database, file system, combination thereof or other data store. The various services may utilize independent data stores such the data store of each service is not accessible by the other services. For example, each of decision requestor 220, decision service 250, data modeling and prediction service 240 may have its own associated database or other data store.

Secure network services 210 include interfaces to interface with client computing devices 202 and information provider systems 204. The interfaces can be configured to, for example, receive and respond to queries from users at client computing devices, interface with information provider systems 204, obtain data from or provide data obtained, or determined, by decision system 200 to client computing devices 202 or information provider systems 204. It will be understood that the particular interface utilized in a given context may depend on the functionality being implemented, the type of network utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries or other type of interface which it is desired to utilize in a particular context. Secure network services 210 provide a walled off segment of the system. Certain information, such as personally identifiable information (PII), is not available, unencrypted, to other components of the software architecture outside of secure network services 210.

In the embodiment illustrated, secure network services 210 include an interface proxy service 212 that receives calls and data from client applications (e.g., a web browser or mobile app accessing a network site) or services of decision system 200, routes calls and data to the services of decision system 200 and routes responses to the client application or calling service as appropriate. Interface proxy service 212 can provide authentication services, assigning unique user IDs to new users, authenticating users when they log back in to decision system 200 and providing other functionality. Once a user has authenticated, interface proxy service 212 can provide context (such as a user ID) that can be passed with requests to other services.

Secure network services 210 may also include data vendor service 214 configured to communicate with information provider systems 204 to request information from the information provider systems 204. For example, data vendor service 214 may include APIs for services at information provider systems 204, such as 3rd party services, that provide data incorporated in decisions. Data vendor service 214 may include APIs dedicated to each information provider system 204.

Encryption services 216 are provided to internally encrypt/decrypt sensitive information, such as PII, and other information received via data vendor service 214 and interface proxy service 212.

At least some data communicated between decision system 200 and a client computing device 202 or information provider system 204 may be encrypted beyond encryption generally used to encrypt communications (such as HTTPs). For example, PII provided by a client application may be encrypted according to a first encryption protocol. Interface proxy service 212 may forward the encrypted PII for use by other services, such as decision requestor 220, which cannot decrypt the information.

Information provider systems 204 may require PII to return information about a user (e.g., the API for a credit reporting agency information provider systems 204 may require inputting a name, address, social security number or other PII to receive a credit report). When data vendor service 214 receives encrypted PII from another service to send to an information provider system 204, data vendor service 214 can call encryption service 216 to decrypt the PII from the internal format and then data vendor service 214 can then encrypt the PII in the encryption format used for the API call to information provider system 204. Similarly if PII is received from information provider system 204 via data vendor service 214, data vendor service 214 can decrypt the PII according to the encryption/decryption used by the particular data vendor, call encryption services 216 to encrypt the PII according to the internal format and forward the encrypted PII to another service. Thus, PII is highly secure because, in some embodiments, it is only ever decrypted at secure network services 210 to be re-encrypted for forwarding to other services.

Interface proxy service 212 and data vendor service 214 may thus be configured with rules regarding which PII is to be encrypted by encryption service 216. Examples of information that can be considered PII based on the rules includes, but is not limited to: first name, last name, middle name, date of birth, email address, government ID numbers (social security numbers, driver's license number), address, driver's license bar code scan, driver's license image, phone numbers, signature, insurance card information, bank account number, bank account name, bank account balance, employment information or other information. In some embodiments, the rules will specify which fields of data in an input from a client application or response from an information provider system 204 are to be internally encrypted according to the internal encryption format.

Decision requestor 220 is configured to communicate with client applications to provide content to client applications and request decisions from decision service 250. According to one embodiment, a client computer 202 may submit a request for a decision (e.g., a request for approval, a request to take an action). Interface proxy 212 routes the request to decision requestor 220 and decision requestor 220 requests a decision from decision service 250. Decision requestor 220 includes rules to map decision results to actions. Thus, the results of the decision can be used by the decision requestor 220 to generate content or determine content to be provided to the client applications.

Decision service 250 includes a decision controller 252, decision engine 254, a decision base 256 and data source definitions 258. Decision service 250 can be an example of decision service 110 for which data vendor service 214, and data modelling and prediction service 240 as data providers 130.

In general, decision engine 254 executes a decision to determine if a set of data meets conditions specified in the decision rules for the decision type and generates an output based on the application of conditions to the data. The data to which the conditions are applied may or may not include the decision inputs. Decisions may reference data sources by decision service 250, predictions from data modeling service and prediction service 240, data from defined data mungers (e.g., data munger 290) and sub-decisions and contain rules that are applied to data obtained from information provider systems 204, prediction scores from data modeling and prediction service 240, munged data, the results of subdecisions, decision inputs or other data.

If a decision references a prediction, decision engine 254 generates a prediction request to data modeling and prediction service 240. Data modeling and prediction service 240 can apply a prediction model (e.g., a set of user defined prediction rules or a machine learning model) to a set of prediction inputs to return a prediction score.

According to one embodiment, data modeling and prediction service 240 receives prediction requests and delegates the request to a specific model if the specific model is specified with the prediction request or to a prediction model 244 selected based on rules. For example, data modeling and prediction service 240 can be configured to delegate a request for a type of prediction (e.g., an income prediction) to a currently active prediction model of the type (e.g., a currently active income prediction model) if the prediction request does not specify a particular prediction model. The currently active prediction models may be set in configuration of service 240.

Decisions and prediction models may require data from information provider systems 204. According to one embodiment, decision service 250 can define and manage data sources, data source versions, data source arguments, and data source records (and store this data in the decision service data store 260). A data source can specify a set of data from one or more information provider systems 204 (e.g., 3rd party services provided by information provider systems 204) that can be passed to other services. For example, a data source may be a report containing data gathered from one or more information sources 204. The decision service 250 maintains a definition of the arguments (data source definitions 258) needed to collect the data for instances of data sources. These data source definitions and argument schemas may be stored in the decision service data store 260.

When decision engine 254 receives a request for a decision where a decision or subdecision references a data source, decision engine 254 confirms what data is required to retrieve an instance of the data source from an information provider system 204 prior to executing an API call to data vendor service 214 to collect the data source instance. For example, if decision engine 254 requires “Report A version 1” data source when processing a decision request and a social security number is required to fetch that report, decision engine 254 can cross reference the required arguments for fetching said data source with the arguments provided to decision service 250 for the generating the decision (for example, by comparing a data source definition 258 for Report A version 1 with the decision input data) and assess whether the dependencies have been met, resulting in a fetching of the data source report, or not, resulting in decision service 250 responding to the decision requestor 220 with what further arguments are needed.

In response to a complete set of arguments, i) decision engine 254 passes the arguments (which may be encrypted or tokenized) to data vendor service 214, ii) data vendor service 214 collects the Report A version 1 instance from an information provider system 204 via the API for the information provider system 204 (which may use encryption service 216 to decrypt/encrypt PII) and iii) data vendor service 214 provides the Report A version 1 instance to decision engine 254. Decision service 250 may cache the report instance so that it can respond to requests for the report within a specified time window with cached data rather than fetching the data again from the information provider system. In some cases, the decision may specify a ‘force’ fetch of a data source, such that decision service 250 fetches a fresh report from data vendor service 214 (e.g., from the third party vendor) rather than using a cached report instance. Similarly, data sources may be specify a number of days until a cached record expires. If a data source specifies 0 days until a record expires then the decision service will skip the cache in all cases and always fetch that data source fresh/

Similarly, when the decision engine 254 receives a request for a decision that references a prediction, the decision engine 254 may not know what data is required to make a prediction required by the decision. The decision engine can call over to the data modeling and prediction service 240 and data modeling and prediction service 240 informs the decision engine 254 of the data needed for the prediction. For example, if decision engine 254 makes a call to prediction service 240 for an “Income Prediction version 1”, the prediction service can inform decision engine 254 of the data sources or other data needed to make the prediction. In response, i) decision engine 254 communicates with data vendor service 214 to collect the data sources as described above; ii) passes the data source instances or other data to the data modeling and prediction service 240; iii) receives the results of the requested prediction from the data modeling and prediction service 240.

Any data sources required and the data from the data sources used by particular rules in decision making can be specified in the decision rules in decision base 256 or prediction models 244 rather than the decision engine code. From the perspective of decision engine 254, gathering data sources and receiving the results of predictions is simplified. For example, decision engine 254, in some embodiments, need only be able to request a data source instance from and pass arguments to data vendor service 270 to receive a data source instance.

Thus, based on the decision type and decision input attributes for the decision that decision engine 254 is being requested to make, decision engine 254 can access the appropriate rules (e.g., from decision base 256), retrieve the required data sources and/or prediction scores, process the decision rules to generate a decision result and return the decision result to the requesting service. The decision result may include the ID of the decision and metadata about the decision including, for example, an indication of whether the decision result was a pass or a fail, prediction scores generated when making the decision, decline codes indicating why the decision failed or other decision metadata.

Decision controller 252 returns the decision result to the calling service. Decision controller 252 may also store data associated with the decision in decision service data store 260 (such as, but not limited to, decision type, decision inputs, model identifier, prediction inputs, prediction scores, data source instances, decision result metadata).

FIG. 3 is a diagrammatic representation of another embodiment of a network topology that includes a decision system 300 coupled through network 305 to client computing devices 302 (e.g. computer systems, personal data assistants, smart phones or other client computing devices) and one or more information provider systems 304. Network 305 may be, for example, a wireless or wireline communication network such as the Internet or wide area network (WAN), publicly switched telephone network (PTSN) or any other type of communication link.

Client computing devices 302 may comprise one or more computer systems with central processing units executing instructions embodied on one or more computer readable media where the instructions are configured to interface with decision system 300. A client computing device 302 may comprise, for example, a desktop, laptop, smart phone or other device. A client computing device may run a client application, such as an application specifically configured to interface with decision system 300 to generate application pages for display to a user, a web browser or other client application.

Information provider systems 304 are systems of entities that provide information used in processing decisions. For example, in an embodiment in which decision system 300 is configured to determine if a user qualifies for financing for a vehicle, information provider systems 304 may include computer systems controlled by credit bureaus, fraud and ID vendors, data vendors or financial institutions. Information provider systems 304 may comprise any number of other various sources accessible over network 305, which may provide other types of desired data.

Decision system 300 comprises one or more computer systems with central processing units executing instructions embodied on one or more computer readable media where the instructions are configured to perform at least some of the functionality associated with embodiments of the present invention. The instructions are executable to provide a software architecture comprising one or more components. In the embodiment illustrated, the software architecture comprises secure network services 310, decision requestor 320, data modelling and prediction service 340, decision service 350 and event queues 375. Each of decision requestor 320, decision service 350, data modeling and prediction service 340 and secure network services 310 may include interfaces, such as APIs or other interfaces, so that other services can send calls and data to and receive data from that service.

The services may utilize various data stores operable to store obtained data, processed data determined during operation, rules/models that may be applied to obtained data or processed data to generate further processed data and other information used by the services. For example, decision requestor 320 may store data used for decision inputs in a data store, data modeling and prediction service 340 stores prediction models 344 in registry 342, decision service 350 stores data in data store 360. The various services may utilize independent data stores such the data store of each service is not accessible by the other services. For example, each of decision requestor 320, decision service 350, data modeling and prediction service 340 may have its own associated database.

Secure network services 310 provide a walled off segment of the system. Certain information, such as PII, is not available, unencrypted, to other components of the software architecture outside of secure network services 310. In the embodiment illustrated, secure network services 310 include an interface proxy service 312 that can operate as described above in conjunction with interface proxy service 212. Secure network services 210 may also include interfaces 314 configured to communicate with information provider systems 304 to request information from the information provider systems 304. Interfaces 314 may include APIs for services at information provider systems 304, such as 3rd party services, that provide data incorporated in decisions. Interfaces 314 may include APIs dedicated to each information provider system 304. Encryption services 316 are provided to internally encrypt/decrypt sensitive information, such as PII, and other information received via interfaces 314 and interface proxy service 312. As discussed above with respect to encryption services 216, encryption services 316 may be called to encrypt/decrypt PII.

Decision requestor 320 is configured to communicate with client applications to provide content to client applications and request decisions from decision service 350 and can operate as discussed above with respect to decision requestor 120 or 220.

Decision service 350 includes a decision controller 352, decision engine 354 and a decision registry 356, which provides a decision base. Decision service 350 can be an example of decision service 110 in which a data layer 370 and data modeling and prediction service 340 act as data providers 130.

Data layer 370 provides an abstraction to interfaces 314, such as 3rd party APIs, that can be used to collect data from information provider systems 304. Data registry 372 may include files or other data that controls what 3rd Party APIs (or other interface) data layer 370 has access to as well as settings on those interfaces, such as Time To Live on documents.

According to one embodiment, data layer 370 defines and manages data sources, data source versions, data source arguments, and data source records. The data layer 370, for example, can maintain a definition of the arguments needed to collect the data for instances of data sources, receive argument values from other services, collect the data via 3rd Party APIs 314 and pass the data source instance to the requesting service. Data layer 370 may also store a data source instance as one or more records in data store 360 so that it can be fetched along with the data source version and inputs that were used to create the data source instance. Data layer 370 may further cache data source instances for faster retrieval in response to a subsequent request for the data source instance.

A decision or prediction model may reference a data source from data layer 370. According to one embodiment, the decision engine 354 does not know what data is required to retrieve a data source instance, but instead calls over to the data layer 370 and the data layer 370 informs the decision engine 354 of the data needed for the data source. For example, if decision engine 354 makes a call to data layer 370 for the “Report A version 1” data source when processing a decision request, and data layer 370 needs a social security number and name to collect an instance of Report A version 1, data layer 370 can inform decision engine 354 of the arguments from the decision input needed to return an instance of the requested data source from the decision input are needed. In response, i) decision engine 354 can pass the arguments (which may be encrypted or tokenized) to data layer 370, ii) data layer 370 can collect the Report A version 1 instance from an information provider system 304 via interfaces 314 and iii) the data layer 370 can provide the Report A version 1 instance to decision engine 354. The instance of the Report A version 1 may be stored in data warehouse 360. Furthermore, data layer 370 may cache the report instance so that it can respond to requests for the report within a specified time window with cached data rather than fetching the data again from the information provider system. In some cases, the decision may specify a ‘force’ fetch of a data source, such that when fetching a data source from the data layer 370, it can force the data layer 370 to fetch a fresh report (e.g., from the third party vendor) rather than using a cached report instance.

A decision may also reference a prediction from data modelling prediction services 340. Data modelling and prediction service 340 maintains predictions models that can receive a prediction input and generate a predictions score. According to one embodiment, the decision engine 354 does not know what data is required to make a prediction, but instead calls over to the prediction service 340 and prediction service 340 informs the decision engine 354 of the data needed for the prediction. For example, if decision engine 354 makes a call to prediction service 340 for an “Income Prediction version 1”, the prediction service 340 can inform decision engine 354 of the data sources or other data needed to make the prediction. In response, i) decision engine 354 can communicate with data layer 370 to collect the data sources as described above; ii) pass the data source instances or other data to the prediction service 340; iii) receive the results of the requested prediction from the prediction service 340. The instance of the prediction, the version, and data used to generate the prediction may be stored in data warehouse 360.

Any data sources required and the data from the data sources used by particular rules in decision making can be specified in the decisions stored in the data registries 356 or predictions stored in registries 342 rather than the decision engine code. From the perspective of decision engine 354, gathering data sources and receiving the results of predictions is simplified.

Thus, based on the decision type and decision input attributes for the decision that decision engine 354 is being requested to make, decision engine 354 can access the appropriate rules (e.g., from decision base 356), retrieve the required data sources and/or prediction scores, process the decision rules to generate a decision result and return the decision result to the requesting service. The decision result may include the ID of the decision and metadata about the decision including, for example, an indication of whether the decision result was a pass or a fail, prediction scores generated when making the decision, decline codes indicating why the decision failed or other decision metadata.

Decision controller 352 returns the decision result to the calling service. Decision controller 352 may also store data associated with the decision in decision service data store 360 (such as, but not limited to, decision type, decision inputs, model identifier, prediction inputs, prediction scores, data source instances, decision result metadata).

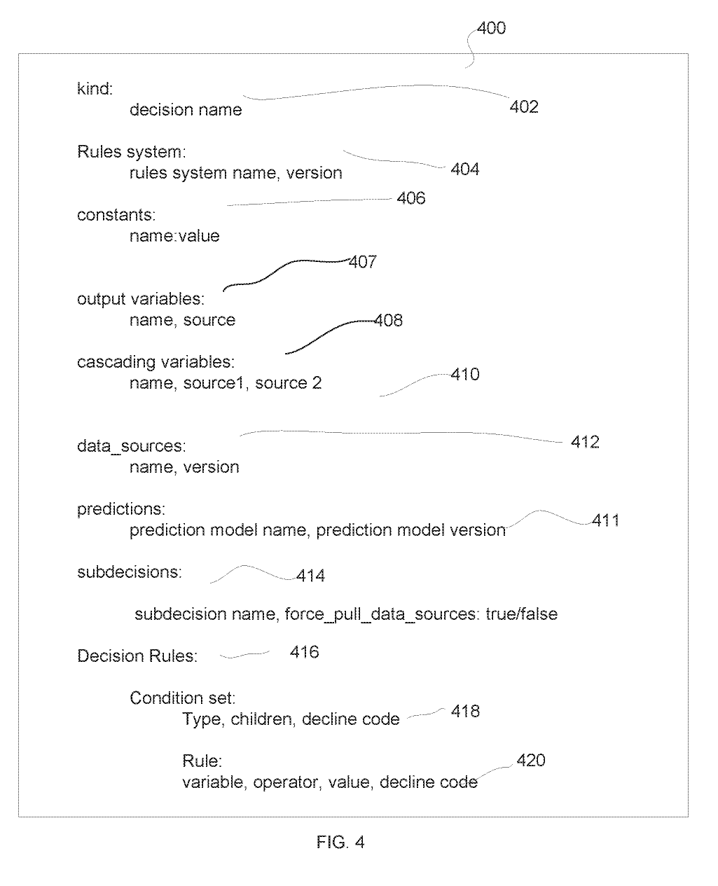

With reference to FIG. 4, a decision 400 may have an associated “kind” (indicated at 402) that indicates the type of decision being implemented. The decision “kind” can be used a decision request and other decisions to reference that decision. In some embodiments, the “kind” may be arbitrarily chosen by the user defining the decision.

In some embodiments, a decision engine may support multiple rules systems, where the rules systems control how the decision engine applies rules in the decisions. In such an embodiment, a decision may specify a rules system (e.g., “Rules_system” indicated at 404). The rules systems may be versioned.

A decision may specify a set of constants (indicated at 406) to be applied to data when servicing a decision request. A constant can be specified as a name/value pair.

A decision may specify various variables. The variables being analyzed for any given decision may refer to values from a decision input, values obtained from the data source, values obtained from a prediction or other values. In some embodiments, the variable names may refer to methods on a decision class that process the decision input or data from data providers (e.g., data from data sources, predictions or other data).

In FIG. 4, decision 400 includes output variables 407. Each output variable can include a name and a value source (e.g., an attribute of a data source, prediction result, decision input or set of munged data). The output variables represent variables that may be passed to other services.

Additionally, decision 400 specifies cascading variables. For each cascading variable, decision 400 includes a variable name and an array of value sources. The decision engine iterates through the value sources to determine a value for a cascading variable.

A decision may specify data to be collected from a data provider (e.g., data provider 130). For example, a decision may specify a set of data sources (indicated at 410) that are required to make this decision and potentially data sources used to make “subdecisions”. The “name” specifies the name of a data source and “version” specifies the version of the data source. Before processing the decision rules in decision 400 for a set of decision input data, the decision engine 114, 254, 354 can determine if it has all the decision input data needed to collect the data sources referenced in the decision. As discussed above, if the decision engine does not have the necessary information, it can request the additional information from the decision requestor.

As indicated at 411, a decision may further reference a prediction model used by a prediction service (e.g., data modelling and prediction service 240, 340). The “name” specifies the name of a prediction model and “version” specifies the version of the prediction model.

A decision may reference separately defined subdecisions on which the decision depends (indicated at 414). In this embodiment, “name” refers to the “kind” specified in the subdecision. The decision may also indicate whether to data sources referenced by the subdecision should be force pulled. If a decision references subdecisions, the decision engine can identify other decisions that it may have to load and for which it may have to access data sources in order to fully process the referencing decision.

A decision specifies decision rules 416. More particularly, a decision can include a condition set, which may include rules and/or nested condition sets. Each condition set may have a condition operator (indicated by “type”) that specifies how the results of applying conditions are evaluated to determine a decision result. For example an “all” operator may specify that all conditions at the next tier down in the condition set must be passed for the condition set to pass, whereas an “any” operator may specify that at least one condition at the next tier down in the condition set must be met for the condition set to pass.

A condition set may have children. A child may be a rule 420 or a nested condition set that has further decedents. A rule 420 may include a “variable” that specifies the value that is being analyzed by a rule. The variables being analyzed for any given decision may refer to values from a decision input, values obtained from the data source, values obtained from a prediction or other values. In some embodiments, the variable names may refer to methods on a decision class that process the decision input or data from data providers (e.g., data sources, prediction results, munged data or other data from data providers) to determine a variable value.

A condition set may include a failure code to categorize types of failures whenever a decision fails to pass a condition set. According to one embodiment, each condition within the decision rules may either explicitly specify the failure code on its node or inherit a failure code from a parent condition. Since the decision system can accommodate arbitrarily complex decision rules and can thus make decisions on any topic or area of domain, the possible number of condition/rule nodes that could fail may be large. Systematizing and assigning condition/rule nodes to a failure code, enables set failure reasons to be categorized into a discrete set of failure codes. This can facilitate other systems and services that ask for decisions from the decision service to understand and be able to react accordingly to any failing/non-passing decision.

Decision rules information may be stored in a variety of formats. For example, decision rules, their output variables, their decision kind, the constants, the prediction models, and cascading variables, may be stored in a rules table containing one or more pieces of decision information 400. Some information may be stored in additional tables. For example, the data sources and subdecision types may be stored in join tables and point to the rules that they are for through a foreign key. Additionally, the resulting decisions may be stored in a decisions table and point to the rules table. In other embodiments, the decision rules may be embodied in files with each file defining a decision type and set of rules.

A decision service (e.g., decision service 110, 250, 350) can provide an interface to allow a user with sufficient privileges to upload or otherwise store decision rules in the decision base. In some embodiments, the decision service may provide an interface with tools to allow a user to compose decision rules, providing menus or other tools that allow the user to select available prediction models and data sources and specify other information used in creating a set of decision rules. In other embodiments, a user may create a decision rule in another tool, such as a text editor, and store the decision rule in the decision base.

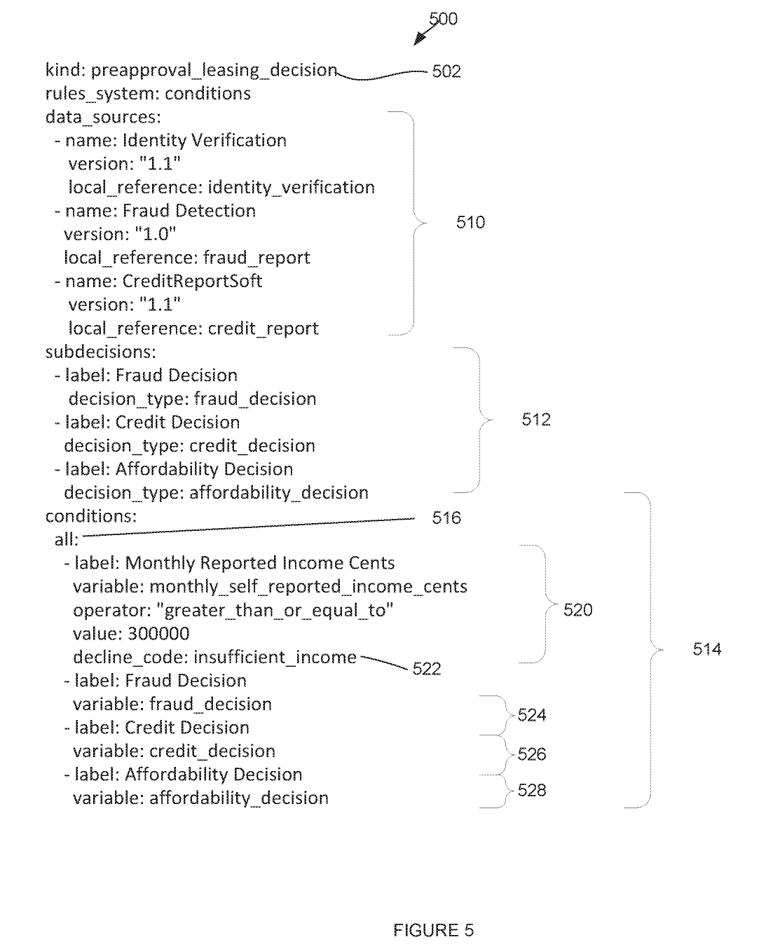

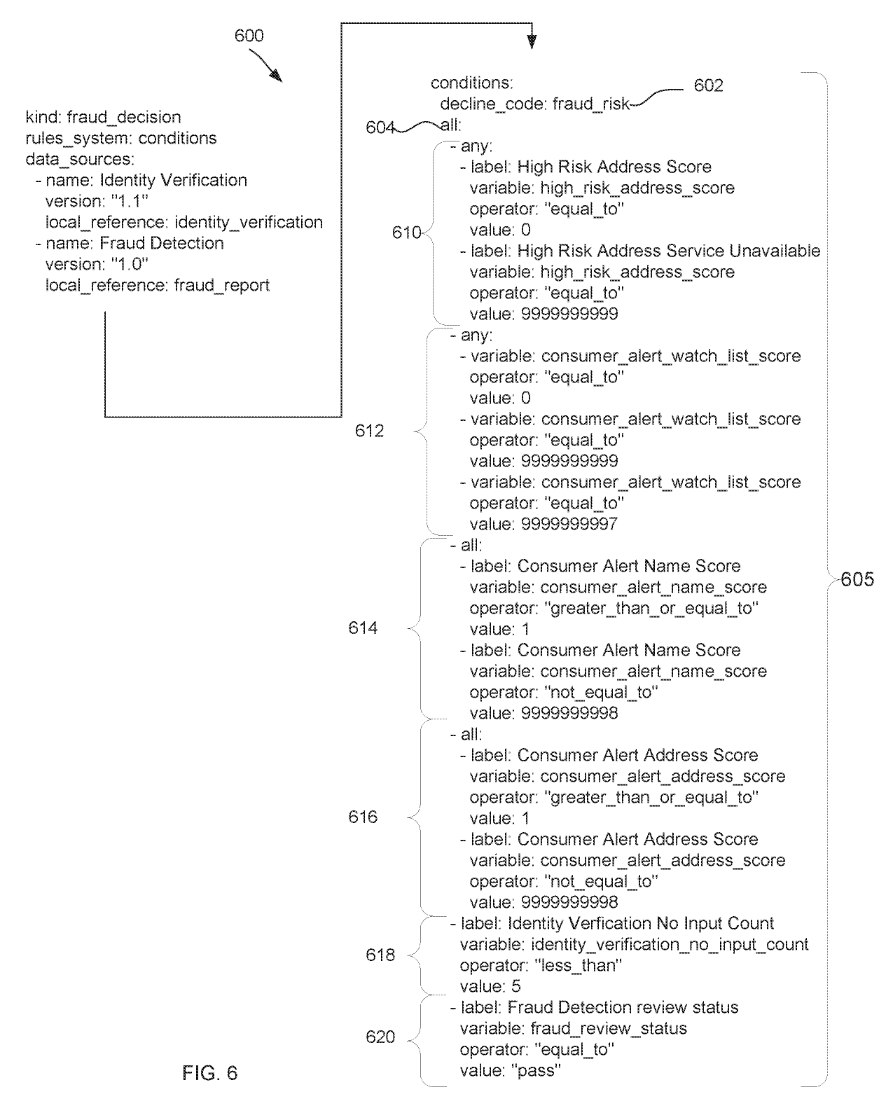

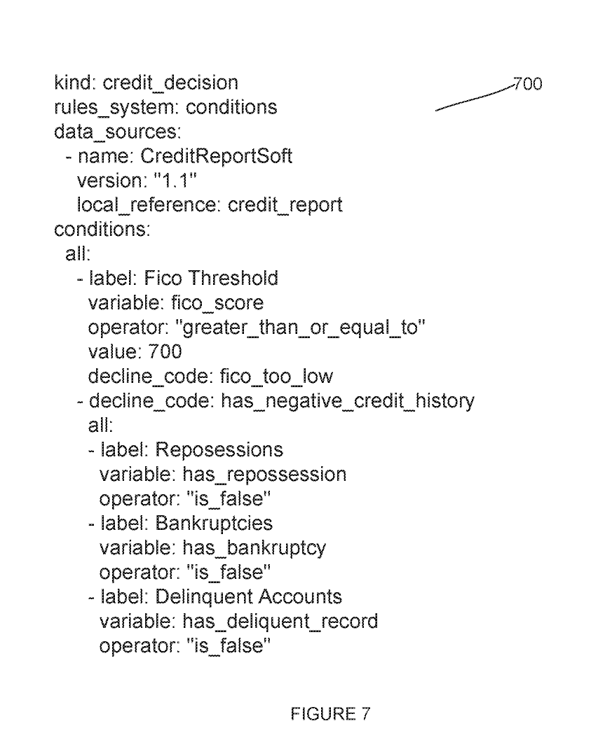

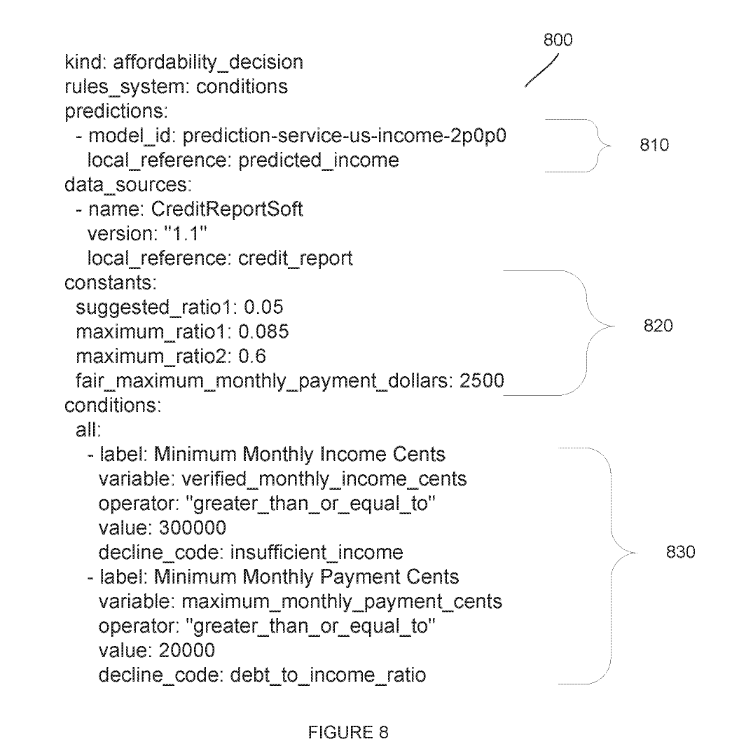

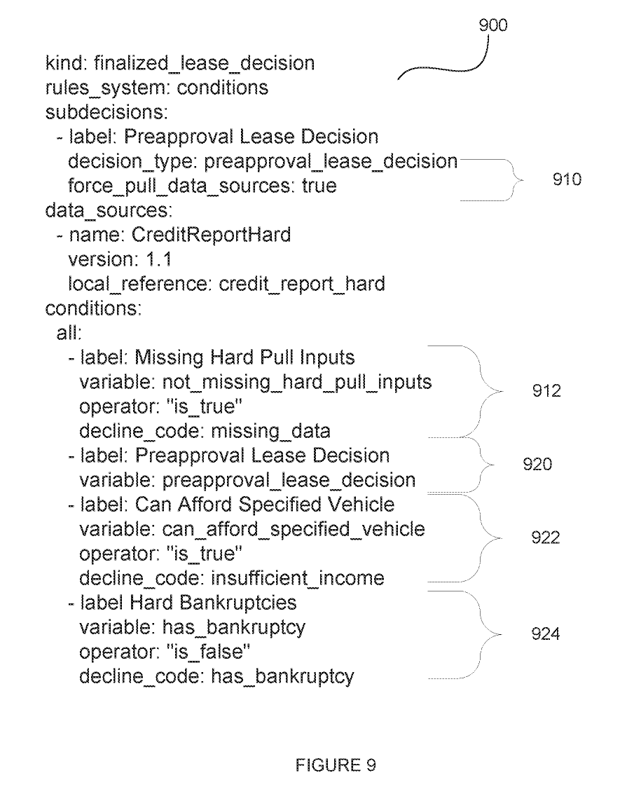

To provide additional context, several example decisions rules are provided below in FIGS. 5-12B. The decision rules are configured for a vehicle data system in which various data sources, prediction models, methods are defined. In the example vehicle data system, the consumer undergoes a preapproval process to initially qualify for financing for up to x dollars a month and final approval process in which the consumer is approved for a selected vehicle. In the example of FIGS. 5-9, the decision base includes preapproval_leasing decision 500 (FIG. 5), fraud_decision (FIG. 6), credit decision 700 (FIG. 7), affordability_decision 800 (FIG. 8) and finalized_lease_decision 900 (FIG. 9). The vehicle data system may include a decision requestor (e.g., decision requestor 120, 220, 320) that can request a preapproval_leasing decision for a set of consumer data or a finalized_lease_decision for a set of consumer data and selected vehicle data.

According to one embodiment, decisions executable by a decision engine (e.g., decision engine 114, 254, 354) are specified according to a domain specific rules language and embodied as files (e.g., YML files) stored in a decision store. The rules language may use a simplified rules syntax. Moreover, the decisions can be stored in a human readable language. The decisions of FIGS. 5-9 are defined using YAML, and may be stored as, for example, text files (YML files) in a decision base. According to one embodiment, each decision is stored as a separate file.

The decision engine is configured such that the syntax of the rules language has meaning to the decision engine. For example, in YAML, an associative array can be represented using colon space (:) (e.g., key: value), list members are denoted by a leading hyphen (-) with one member per line or separated by a comma space (,) and whitespace indention is used to donate structure. According to one embodiment, the decision engine (e.g., decision engine 114, 254, 354) is configured such that particular keys specify how values in an associative array (including list members or nested associated arrays) are to be processed. Furthermore, the decision engine is configured such that the structure indicates relationships between decisions, data from data providers (e.g., data sources, predictions, munged data), sub-decisions and rules.

In the examples of FIGS. 5-9, it is assumed that the following data sources are defined in the vehicle data system: Identity Verification version 1.1, Fraud Detection version 1.0, CreditReportSoft version 1.1, CreditReportHard version 1.1 and Projected Income version 1.1. The data sources represent data from various online information provider systems (e.g., information provider systems 204, 304). For example, the data sources may include defined sets of data from online fraud detection services, identity verification services, income projection services and credit reporting agencies.

It is also assumed that the prediction model prediction-service-us-income version 2p0p0 is maintained by a prediction service (e.g., data modelling and prediction service 240, 340). It is further assumed that prediction-service-us-income version 2p0p0 uses data from a suggested_ratio1, maximum_ratio1, maximum_ratio2, monthly_self_reported_income_cents, system_maximum_monthly_payment_dollars, CreditReportSoft version 1.0 and Projected Income 1.0. Suggested_ratio1, maximum_ratio1, maximum_ratio2 and system_maximum_monthly_payment_dollars are defined in decision 800 and monthly_self_reported_income_cents is extracted from the decision input.

FIG. 5 illustrates an example of a preapproval_leasing_decision (indicated at 502). “Data_sources” (indicated at 510) indicates the data sources that are required to make this decision and potentially data sources used to make “subdecisions”. More particularly, the key and colon with space “data_sources:” indicates that an array of data sources will follow. The indented hyphens (-) indicate new items in the array. The whitespace indention of the keys “name”, “version” and “local_reference” indicate that the values define the name, version and local_reference for a particular data source in the data_sources array. The whitespace indentation of “subdecisions:” indicates that the data_sources array is complete and that the subdecisions array is a new array, not a value of the data_sources array.

In this example, decision rules 500 specifies three data sources. According to one embodiment, the decision engine does not know what data is required to retrieve a data source, but instead calls over to the data provider that provides instances of the data source (e.g., data provider 130, data layer 370) and the data source provider informs the decision engine of the data needed for the data source. As an example, when servicing a request for a preapproval_leasing_decision on a set of consumer data, the decision engine may make a call to the data provider for the arguments required to retrieve the “Identity Verification version 1.1” data source and the data provider may respond that it requires a social security number and name to collect an instance of the Identify Verification version 1.1 report. In another embodiment, the decision service maintains a definition of the attributes required to collect instances of data sources (e.g., definitions 218 of FIG. 2).

Continuing with the previous example, i) decision engine can pass an encrypted or tokenized social security number and name received in the decision input to the data provider, ii) the data provider can collect an instance of the Identity Verification version 1.1 report from an information provider system and iii) the data provider can provide the instance of the Identify Verification version 1.1 report to the decision engine. The instance of the Identity Verification version 1.1 may have multiple attributes with values corresponding to the consumer for whom the decision was requested.

“subdecisions” (indicated at 512) lists separately defined subdecisions on which decision rule 500 depends. Because decision rules 500 relies on subdecisions, the decision engine can identify other decisions that it may have to load and for which it may have to access data sources in order to fully process decision rules 500.

Decision rules 500 specifies a set of conditions (e.g., condition set 514), which may include rules and/or nested condition sets. In FIG. 5, condition set 514 includes rules 520, 524, 526 and 528. Each condition set may have a condition operator 516 that specifies how the results of applying conditions are evaluated to determine a decision result. In the embodiment of FIG. 5, the condition operator “all” means that each of the conditions at the next tier down has to be true (each rule 520, 524, 526, 528 must be pass (e.g., result in a pass or true or some other indication that the condition was met) for decision rules 500 to result in a “pass”, “true” or other indication that decision 500 was satisfied for a decision input). If the condition operator 514 is changed to “any”, then decision rules 500 would result in a pass if any condition at the next tier down was true (e.g., at least one of the rules 520, 524, 526 or 528 resulted in a true).

In the example illustrated, each rule includes a “label” which provides a label that is easily human readable for convenience. “variable” specifies the value that is being analyzed by a rule. The variables being analyzed for any given decision may refer to values from a decision input, values obtained from the data source, values obtained from a prediction or other values. In some embodiments, the variable names may refer to methods on a decision data munger that process the decision input, data sources or prediction results to determine a variable value. For example, monthly_self_reported_income_cents may be a method on the preapproval_leasing_decision class that extracts a value for monthly_self_reported_income_cents from the decision input passed to the decision engine. For example, if a user enters a self-reported income of $2800 when applying for financing, the decision input may contains a value of 2800 for monthly_self_reported_income_cents, the method monthly_self_reported_income_cents can return a value of 280000. A variable name may also refer directly to an attribute of a decision input, data source or prediction result. For example, the variable fico_score in FIG. 7 may refer directly to a fico_score attribute in credit_report.

“operator” and “value” provide the logical operation that is applied by the rule to the variable.

A failure code 522, labelled “decline code” in FIG. 5, is a value that is generated when the result of a condition is false and may indicate the reason that the condition was not met. While failure code 522 is set for the individual rule 520, failure codes may also be set for a condition set.

Rules 524, 526, 528 do not specify an operator or failure code. Instead, because these rules reference subdecisions in the subdecisions array, the decision engine can be configured to automatically apply operator: “equal_to” value: “pass” (or other default value returned to indicate that the requirements of a decision were met). For example, rule 524 can be interpreted by decision engine 150 as:

-label: Fraud Decision variable: fraud_decision operator: “equal_to” value: “pass”.

It can also be noted that rules 524, 526, 528 do not include a failure code. For a condition involving a subdecision, the parent decision's failure code for the condition can apply to all subdecisions in that condition (through one or more generations of subdecisions) unless the subdecision has a more specific failure code. As shown in FIG. 6, 7, 8, discussed below, the fraud, credit and affordability decisions do have more specific failure codes that can be used if those decisions result in declining a request. For example, if the fraud_decision results in “fraud_risk” (FIG. 6) for a decision request, the decision engine may return failure code fraud_risk in response to the decision request.

According to one embodiment, every decision must have a failure code, whether set for the individual condition or condition set in a decision, inherited from a parent decision or surfaced from a subdecision. In an embodiment in which each condition must have a failure code, the decision engine can determine whether a decision is a valid decision based, at least in part, on whether the decision includes a failure code or a chain of subdecisions includes a failure code.

When servicing a decision request, the decision engine evaluates rules 520, 524, 526 and 528 in order. If each rule 520, 524, 526 and 528 is satisfied, the decision result for preapproval_leasing_condition can be set to “pass” or other value to indicate that decision 500 was satisfied. If the conditions of rule 500 are not satisfied, the decision engine can return the appropriate failure code to the decision requestor. More particularly, if rule 520 is not satisfied, the decision result for preapproval_leasing_condition can be set to “insufficient_income”; if rule 524 is not satisfied, the decision result for preapproval_leasing_condition can be set to “fraud_risk” (see FIG. 6); if rule 526 is not satisfied, the decision result for preapproval_leasing_condition can be set to “fico_too_low” or “has_negative_credit_history” based on what is returned by credit_decision 700 (see FIG. 7); if rule 528 is not satisfied, the decision result for preapproval_leasing_condition can be set to “insufficient income” or “debt_to_income_ratio” based on what is returned by affordability_decision 800 (see FIG. 8).

Turning to FIG. 6, one embodiment decision rules 600 for a decision kind/type of fraud is illustrated. Decision rules 600 follows a similar syntax as decision 500. Of note, decision rules 600 includes decline_code 602. Here, because the failure code is at the top level of condition set 605 (rather than as part of a particular condition as in rule 520), the decision engine will output the same failure code regardless of which condition in condition set 605 is not met.

Furthermore, condition set 605 includes nested condition sets 610, 612, 614 and 616 as conditions. The condition operator “all” at 604 applies to the conditions 610, 612, 614, 616, 618, 620 at the next tier down. Thus, if any of condition 610, 612, 614, 616, 618, 620 is false, decision 600 will result in a failure code of fraud_risk. As several of the conditions are themselves conditions sets, the conditions may have their own condition operators. For example, the condition operator for condition subset 610, is set to “any”, such that only one of the conditions at the next tier down has to be true for that condition set to be true (e.g., only one rule of condition subset 610 has to be true for condition subset 610 to be true).

high_risk_address_score, consumer_alert_watch_list_score, consumer_alert_name_score, consumer_alert_addresss_core, identity_verification_no_input_count may be methods on the fraud decision data munger class for processing the identity_verification report to extract particular values or may directly reference attributes of identity_verification (e.g., an instance of the Identity Verification version 1.1 data source may include attributes having the names high_risk_address_score, consumer_alert_watch_list_score, consumer_alert_name_score, consumer_alert_address_score, identity_verification_no_input_count). The variable fraud_review_status may be a method on fraud_report to extract a flag indicative of whether a set of consumer information indicates fraud or may directly reference an attribute of fraud_report (e.g., an instance of the Fraud Detection version 1.0 data source may include an attribute having the name fraud_review_status).

In the illustrated example: if high_risk_address_score is equal to 0 or high_risk_address_score is equal to 9999999999, then condition set 610 is true; if consumer_alert_watch_list_score is equal to 0, 9999999999 or 9999999997, then condition set 612 is true; if consumer_alert_name_score is greater than 1 and not equal to 9999999998, then condition set 614 is true; if consumer_alert_address_score is greater than 1 and not equal to 9999999998, the condition set 616 is true; if identity_verification_no_input_count is less than 5 then condition 618 is true; and if fraud_review_status equals “pass”, then condition set 620 is true.

With reference to FIGS. 5 and 6, because condition operator 516 applies to rule 524, a request that fails decision 600 will fail decision 500.

Turning to FIG. 7, one embodiment of a credit decision rules 700 is illustrated. Decision rules 700 follows a similar syntax as decision rules 500 and 600. The variables fico_score, has_repossession, has_bankruptcy, has_delinquent_record may be methods of the credit decision data munger class or directly reference attributes of data sources, decision inputs, or predictions (e.g., an instance of the CreditReportSoft version 1.1 data source may include attributes having the names fico_score, has_repossession, has_bankruptcy or has_delinquent_record). With reference to FIGS. 5 and 7, because condition operator 516 applies to rule 526, a request that fails decision rules 700 will fail decision rules 500.

FIG. 8 illustrates one embodiment of an affordability decision 800 that follows a similar syntax as decision rules 500, 600, 700. Decision rules 800 includes a model reference 810 referencing the affordability prediction prediction-service-us-income-2p0p0 (e.g., a model maintained by data modelling and prediction services 240, 340). As with data sources, predictions can be versioned. Thus, for example, 2p0p0 represents a prediction version. For every prediction result, the decision engine can record the inputs that were required to make that prediction, the model (and version) used to make the prediction and the prediction results. Decision rules 800 also illustrates an example of a decision declaring constants.

A prediction may require data from data sources or from variables or constants defined in a decision. For example, in order to return a prediction result, prediction-service-us-income-2p0p0 may require an instance of Projected Income version 1.1, an instance of CreditReportSoft version 1.1, and values from monthly_self_reported_income_cents, suggested_ratio1, maximum_ratio1, maximum_ratio2 and system_maximum_monthly_payment_dollars. When decision rules 800 are processed to generate a decision, the decision service can call the prediction service and request a prediction using prediction-service-us-income-2p0p0. The prediction service may request data needed to make the prediction (e.g., Projected Income version 1.1, CreditReportSoft version 1.1, suggested_ratio1, maximum_ratio1, maximum_ratio2, monthly_self_reported_income_cents, system_maximum_monthly_payment_dollars). The decision service can request the data sources from the data provider (e.g., data provider 130, data vendor service 214, data layer 370), determine the variable values and pass the instances of the data sources, variable values and constant values to the prediction service. The prediction service applies the appropriate prediction model to the data from the data source instances and other data to return prediction results. In this example, the prediction service returns a prediction result, predicted_income, which, for the sake of example, includes a value for a verified income and an affordability score for the consumer (a prediction of the maximum payment that the consumer can afford).

verified_monthly_income_cents and consumer_maximum_monthly_payment_cents may be methods on the affordability_decision data munger. The verified_monthly_income_cents method can use the verified income value from predicted_income to determine a verified monthly income in cents. consumer_maximum_monthly_payment_cents may be a method that uses the affordability score for the consumer to determine a user maximum monthly payment in cents. According to the example decision rules 800 and condition set 830, the consumer must have a verified monthly income of greater than $3,000 and be predicted to afford at least a monthly payment of $200 to pass decision 800.

With reference to FIGS. 5 and 8, because condition operator 516 applies to rule 528, a request that fails decision rules 800 will fail decision 500.

FIG. 9 illustrates one embodiment of a final financing decision rules 900. The final decision 900 depends on the consumer passing decision rules 500 (condition 920), which depends in turn on decisions rules 600, 700 and 800. As indicated at 910, decision rules 900 includes an operation 910 to force pull the data sources referenced by the preapproval lease decision (decision rules 500) and thus, not rely on a previously cached version of the data sources.

In the example of decision rules 900, all of conditions 912, 920, 922, 924 must be true for decision rules 900 to return a pass. According to condition 912, not_missing_hard_pull_inputs is a method on finalized lease decision data munger that determines if the decision engine has all the data necessary information to make a hard credit pull for a consumer (all the attributes needed to retrieve the instance of CreditReportHard version 1.1. for the set of consumer data). If condition 912 is not true for a decision request, the decision engine can return a response of missing_data to the requesting service and the requesting service can provide the missing attributes if available.

According to condition 920, the decision preapproval_leasing_decision 500 must return a pass for the set of consumer information. Thus, to evaluate condition 920, the decision engine re-executes the preapproval_leasing_decision 500, and hence, subdecisions 600, 700, 800 for the consumer (condition 920).

According to condition 922, the consumer must be able to afford the monthly payment for the vehicle selected. can_afford_specified_vehicle is a method on the finalized lease decision data munger class that compares the monthly payment for the vehicle selected by the consumer with the consumer maximum monthly payment returned by the prediction service (e.g., at execution of decision rules 800). If the vehicle monthly payment, which may be received in the decision input for a finalized_lease_decision request, is less than the affordability score, the method can return a value of “true.”

According to condition 924, the consumer's hard pulled credit data must show that the consumer has no bankruptcies. In this case, has_bankruptcy may be a method on the finalized lease decision data munger class or directly reference an attribute of credit_report_hard (e.g., an instance of the CreditReportHard version 1.1 data source may include attributes having the name has_bankruptcy). Because final decision rules 900 references the subdecision 500 before CreditReportHard, decision engine 150 can wait for decision rules 500 to be fully executed before pulling hard credit data. Thus, if the consumer fails the preapproval_leasing_decision, the decision does not request the CreditReportHard.

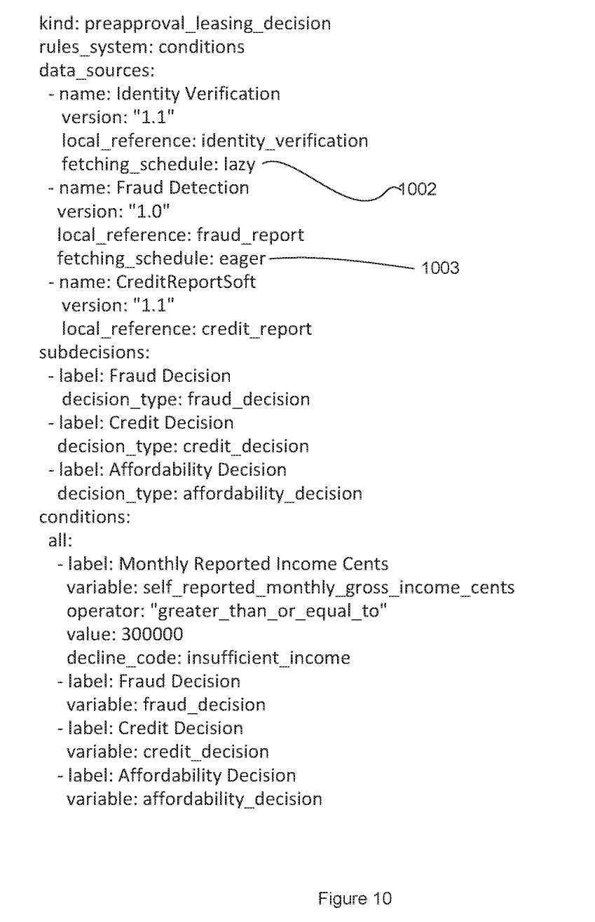

In some embodiments, a decision may specify a schedule for fetching data from a data provider (e.g., a data provider 130). FIG. 10, for example, illustrates an example decision providing examples of specifying “eager” and “lazy” fetching of data, indicated at 1002 and 1003 respectively. The subsection of the decision rules that specifies the data_sources needed can specify whether the data sources are eager or lazy loaded. With each data source, a “fetching_schedule” can be specified. If a fetching schedule is not specified, then the default may be to “eager” fetch the data source.

When decision engine is processing a decision to respond to a decision request, the data engine can begin fetching instances of the data sources on the eager fetching schedule at the beginning of the decision. According to one embodiment, the data source instances may fetched in separate threads so that fetching the data source instances does not block the decision. However, when a decision rule node/condition that needs a particular data source instance is being processed, fetching the data source instance can block the decision from being processed to allow fetching of the data source instance to complete. For a data source that has a lazy fetching schedule, the decision engine begins to fetch the data source instance when it is required within the decision rule conditions/nodes.

In addition to ‘lazy’, and ‘eager’, a decision may include a pointer to a function that returns a Boolean for whether the data source should be fetched. For instance, if one data source should only be fetched if another data source has been fetched (e.g., if the instance of the CreditReportSoft version 1.1 data source should only after the instance of the Fraud Detection version 1.0 data source is fetched), that could be specified in a function and used in the decisions.

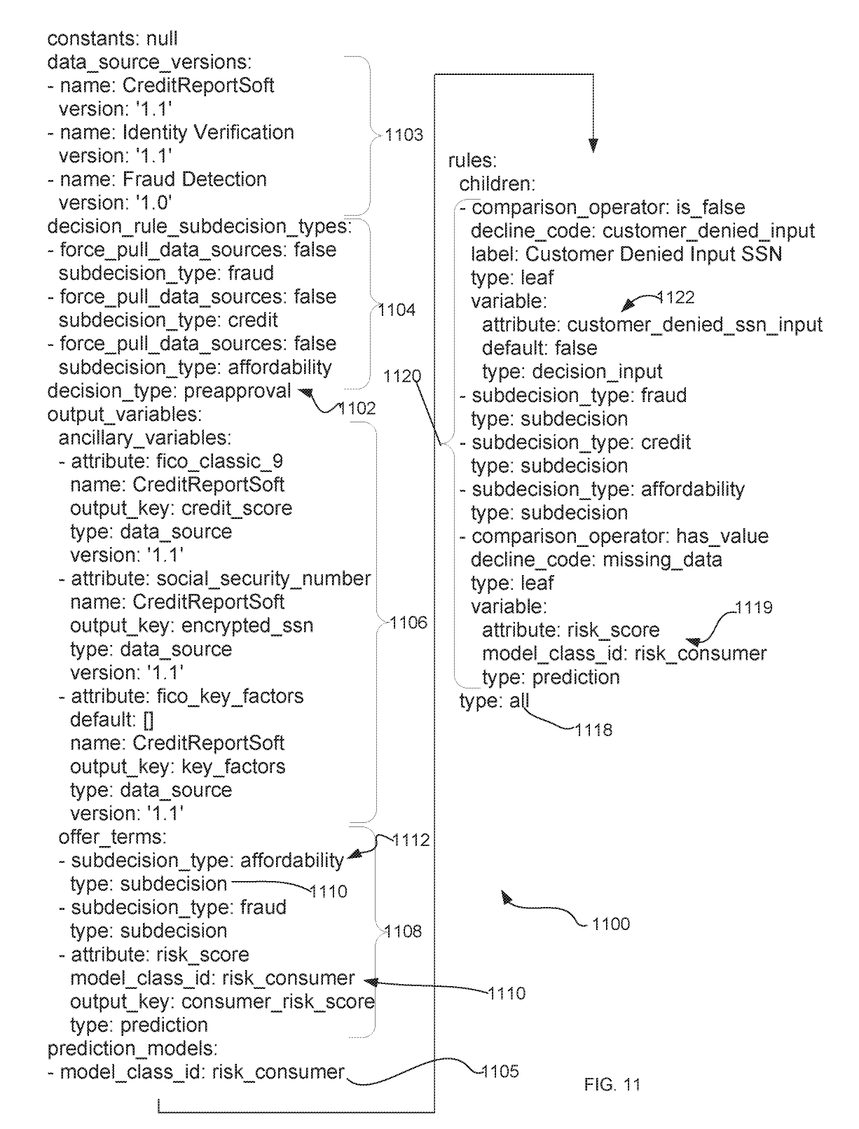

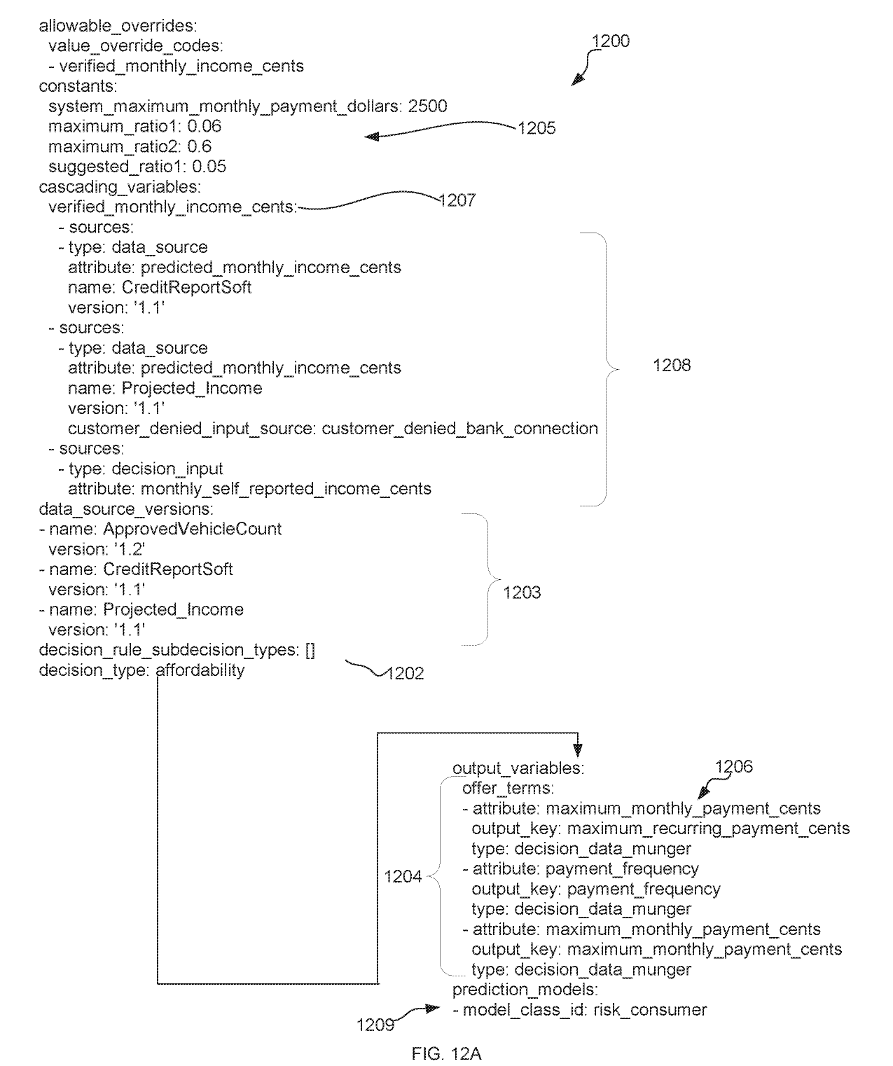

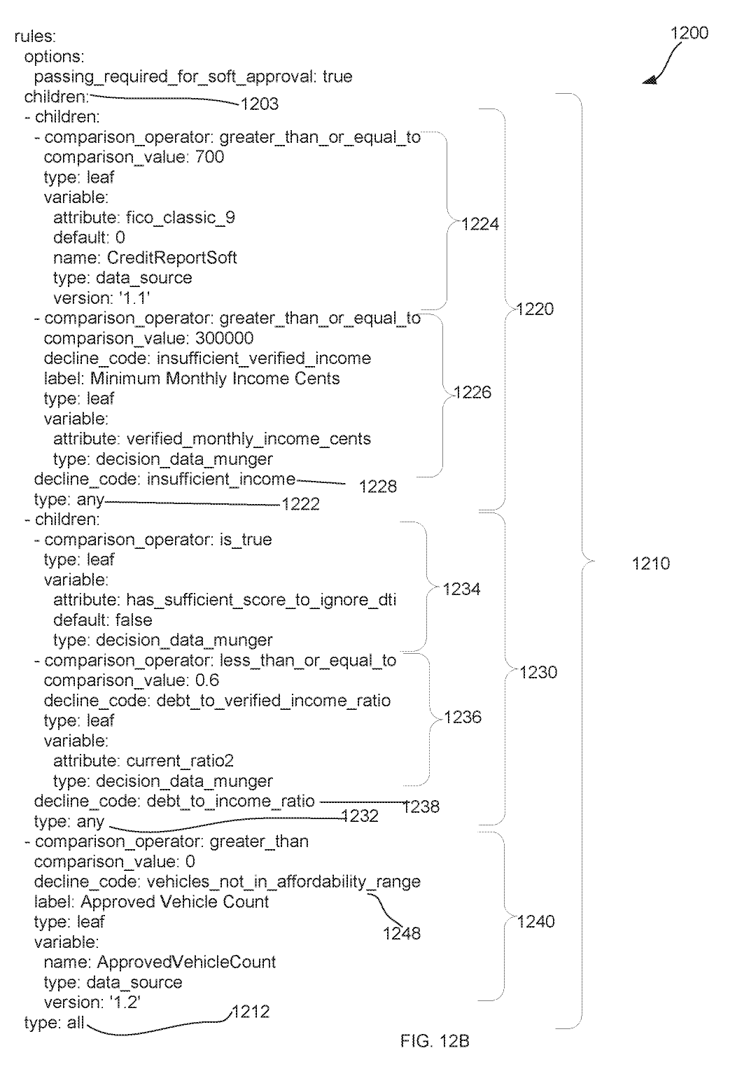

As will be appreciated by one of ordinary skill in the art, a variety of syntaxes can be used to express decisions. FIG. 11 illustrates an example of another embodiment of a preapproval decision rules 1100 and FIGS. 12A and 12B illustrate another embodiment of an affordability decision rules 1200, both provided in YAML. It is assumed for the purposes of discussion that the additional data source ApprovedVehicleCount version 1.2 and a prediction model risk_consumer are defined.

In general, decision rules 1100 and 1200 can include similar information as discussed previously, such as a decision type (indicated at 1102, 1202), data sources (indicated at 1103 and 1203), subdecisions (indicated at 1104), constants (indicated at 1205), prediction models (indicated at 1105 and 1209), variables, conditions, failure codes and other information.

As discussed above, a decision may specify constants and variables. The variable names may refer to methods on a decision class that process the decision input or data from data providers (e.g., data sources, prediction results, munged data or other data) to determine a variable value. A variable name may also refer directly to an attribute of a decision input, data source or prediction result. For example, 1122 specifies to source the variable from the decision input (via the type attribute) and specifies the attribute from the decision inputs to use (customer_denied_ssn_input). Similarly, 1119 indicates sourcing a variable from a prediction (type is specified as prediction) with the prediction model type being risk_consumer.

In decision rules 1100, the decision defines output variables comprising ancillary variables 1106 and offer terms 1108. Output variables, along with the failure codes, define outputs that decision engine (e.g., decision engine 114, 254, 354) provides to the requesting service or data provider. A decision may refer to an output variable of a sub-decision. In FIG. 12, for example, the reference to “-subdecision_type: affordability” at 1112 indicates that the offer_terms array includes the offer_terms variables defined in affordability subdecision. The value of an output variable may further be set to a value provided by a data provider (e.g., a prediction returned by a prediction service (as indicated at 1110), an attribute from a data source, a value returned by a data munger (as indicated at 1206)). In order for a decision to be a positive decision (e.g. approved for vehicle financing), it must have a complete set of offer terms 1108 (in addition to passing the decision rules). These offer terms 1108 are the terms of approval for approved decisions. The ancillary variables are outputs that the requesting service might request. For example, if a decision is declined for vehicle financing then the specific reasons from the consumer's credit report can be surfaced to the requesting service in order to display to the user.

A decision may further define cascading variables. For example, decision 1200 defines variable verified_monthly_income_cents as a cascading variable (indicated at 1207) and provides an array 1208 of sources to use to determine the variable value. In this case, verified_monthly_income_cents causes the decision engine to iterate through each of the sources listed in order and run the decision rules to determine if they pass. If they do not pass and there is a set of decision inputs that the decision requesting service can provide to overcome them, then the decision engine does not cascade to the next cascading variable source and instead responds to the requesting service with the next set of inputs to provide. If there are no available next decision inputs and the decision rules did not pass for a given source of a cascading variable, then it cascades to the next variable source and reevaluates the rules with that source. For example, according to FIG. 12A, the decision engine will first attempt to populate verified_monthly_income with predicted_monthly_income_cents from an instance of the CreditReportSoft version 1.1 data. If a predicted_monthly_income_cents cannot be extracted from the instance of CreditReportSoft version 1.1, or the decision rules fail to pass with the relevant failing nodes using that cascading variable and there is no next decision input that would resolve that for the user, the decision engine will attempt to populate verified_monthly_income_cents from the attribute predicted_monthly_income_cents from an instance of Projected_Income version 1.1. If an instance of Projected_Income version 1.1 cannot be collected for the consumer (e.g., the information provider returns customer_denied_bank_connection) the decision can cascade to the next source and populate verified_monthly_income with the monthly_self_reported_income_cents using the decision input.

As illustrated in FIG. 11, a condition set is denoted by the key “children.” A children array defines a set of condition nodes that are children of the parent decision. A condition node may include a rule or further condition set. The next condition operator (e.g., type: any or type: all) at the same level as a “children” key sets the condition operator that applies to the results of the children condition nodes. For example, the condition operator 1118 means that all the conditions in condition set 1120 must pass for decision 1100 to return a pass.

Condition sets can be nested. Turning to FIG. 12B, rule 1200 defines condition set 1210 having condition operator 1212. The values of the children condition array denoted by “children:” indicated at 1203 includes further children condition sets (“children:” arrays) 1220 and 1230 and rule 1240. According to condition operator 1212, each of condition set 1220, condition set 1230 and condition 1240 must be true in order for decision 1200 to pass.

Condition set 1220 includes condition operator 1222 that applies to conditions 1224 and 1226. Thus, at least one of condition 1224 or 1226 must be true for condition set 1220 to be true. If condition set 1220 is not true for a set of data, the decision engine can return the failure code 1228.

Condition set 1230 includes condition operator 1232 that applies to conditions 1234 and 1236. Thus, condition 1234 or 1236 must be true for condition set 1230 to be true. If condition set 1230 is not true for a set of data, the decision engine can return the failure code 1238. If condition set 1210 fails because of condition 1240, the decision engine returns decline code 1248.

It can be noted that, in the embodiment of FIGS. 11 and 12, the decision rules specify, for each terminal node (leaf node) where to source the data to resolve that node. For example, decision 1100 specifies in rule 1122 that the data for rule 1122 is an attribute of the input data. When a decision tree data structure is created to represent decision rules 1100 the leaf node representing rule 1122 can thus specify how to source the data for the node.

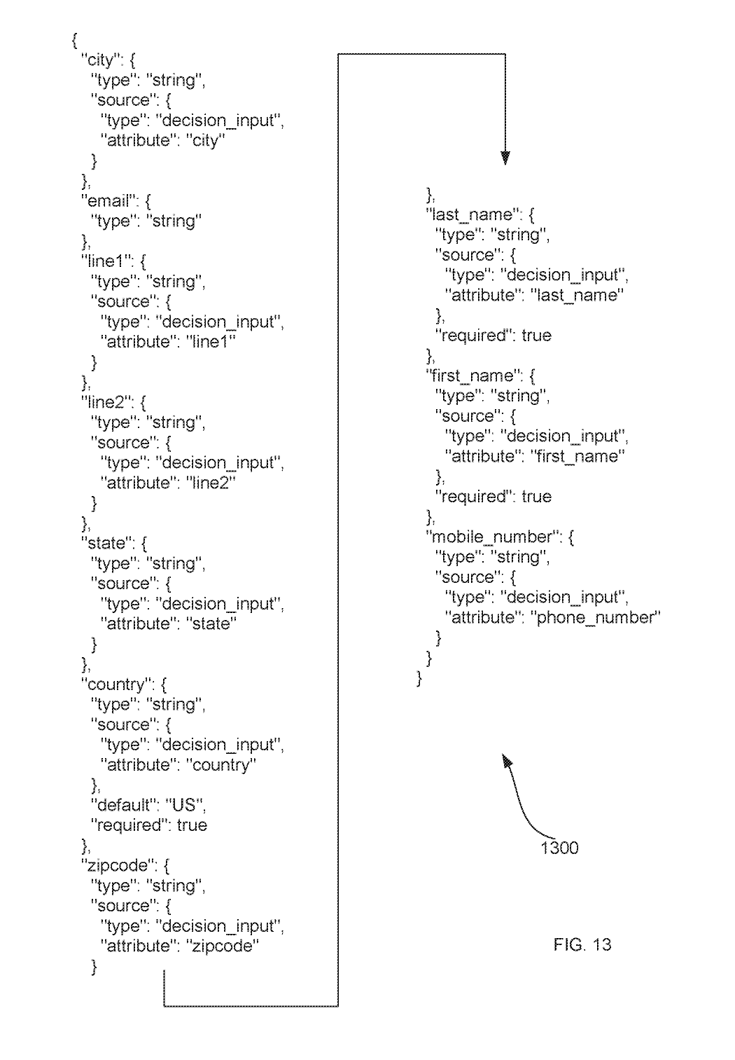

As discussed above, a decision or prediction model may reference data sources. A decision service (decision service 110, 250 350) or other service may maintain a definition of attributes required to retrieve an instance of a data source. According to one embodiment, the definition of attributes may be maintained as an argument schema. FIG. 13, for example, illustrates one embodiment of an argument schema 1300 for a data source CreditReportSoft version 1.1. In this example, the definition is provided in JSON, but could also be provided according to other languages, such as YAML. The definition lists the arguments, in the form of attributes to be provided to the data provider (e.g., data vendor service 214 or data layer 370). For each argument, the schema for a data source lists where to source the value of the argument. In the example of FIG. 13, all the values are sourced from the decision input. In other cases, however, data for arguments may be sourced from other data sources, predictions, data mungers or decision outputs.

In this example, when decision engine determines that it must fetch an instance of CreditReportSoft version 1.1 for a decision request, the decision engine confirms what data is required to retrieve the data source accesses data source definition 1300 and determines that country, first name and last name are required (due to the required key being specified with a boolean value of true). For each argument in the data source definition 1300, it specifies a source for where to get the data for that argument. For example, the sources in 1300 are all decision_input with the attribute key specifying which attribute from the decision input it should be sourced from. The sources for a data source definition are the same as for a decision rules leaf node or the sources for a decision rules output variables. Specifically, the sources can include decision inputs, data sources, predictions, and the outputs from a decision. This enables a data source to utilize the results of any of those other sources as inputs to fetching it, which further expands the capabilities of the system. For example, a data source could be the count of approved vehicles in the live inventory. The data source definition could specify the inputs of the max monthly payment and risk score of the consumer. Thus, the data source would return the count of vehicles given consumer's specific max monthly payment and risk score. Given that the risk score could originate from a prediction and the max monthly payment could originate from a decision data munger that itself combines together other data sources about the user, this enables the system to build more robust directed acyclic graphs. Decision engine cross references the required arguments for fetching said data source with the source of each argument (e.g. the decision input from the decision requestor) and assess whether the dependencies have been met, resulting in a fetching of an instance of the data source, or not. If the source (e.g. decision input) lacks the required attributes, the decision engine requests the missing attributes from the decision requestor. If the source is another data source (herein called data source B), then the decision engine reflects on if there are any inputs to data source B that could be requested in order to fetch data source B with a more complete set of inputs. The decision engine walks back up the dependency graph until it finds a decision input it can request from the requesting service that might resolve the missing data. In response to receiving the required attributes, the decision engine calls the data provider to request the instance of the data source using the required attributes and any optional attributes for which the decision engine has data.

The example decisions and syntaxes provided in FIGS. 5-13 are provided by way of example and not limitation. Decisions, data sources and predictions and relationships between decisions, data from data providers (e.g., data sources and predictions), subdecisions and rules can be expressed in other formats. For example, a decision engine may be configured to process a markup language, such as XML, where the tags and order of tags have meaning to the decision engine. In another embodiment, decisions, data source arguments, rules and other data may be stored in a relational database in which column names or keys have meaning to the decision engine.

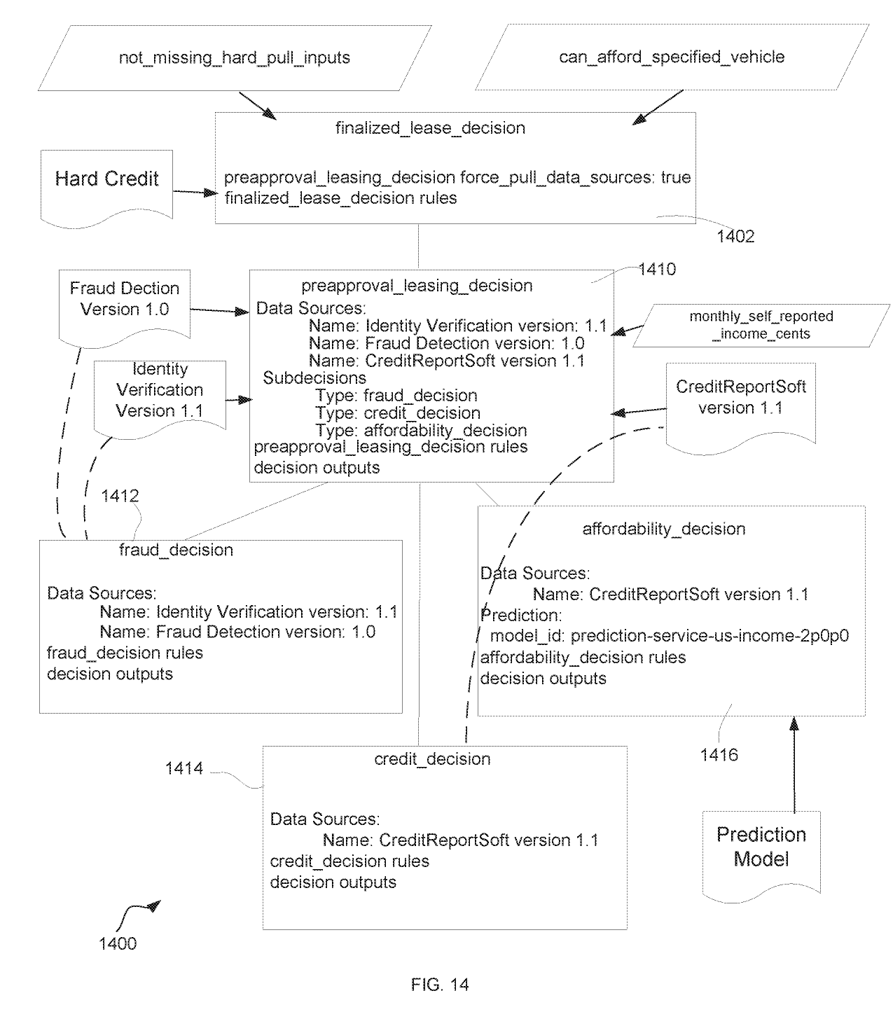

In any event, a decision service (e.g., decision service 110, 250, 350) may receive a request to execute any of the decisions in its decision base. According to one embodiment, the decision engine (e.g., decision engine 114, 254, 354) builds a decision tree data structure, such an acyclic graph representation, for the requested decision and uses the graph to control fetching of data and applying conditions. FIG. 14 illustrates one embodiment of a decision tree 1400 for final_lease_decision 900. Node 1402 represents decision 900, node 1410 represents decision rules 500, node 1412 represents decision 600, node 1414 represents decision rules 700 and node 1416 represents decision rules 800.

The decision service can process the tree beginning at the node for the requested decision and including the sub-decisions, through n number of levels of decisions. According to one embodiment, the decision engine traverses the tree in a depth-first fashion. For example, for a request for a preapproval_leasing_decision, the decision engine can process the portion of tree 1400 beginning at node 1420. In response to a request for a finalized_lease_decision, the decision engine can process the tree 1000 beginning at node 1402.

Decision tree 1400 defines the sources of data, variables and models to be loaded, constants to be set and outputs for each level of the tree. The decision engine walks the tree beginning at the node representing the requested decision, determines the data sources required to execute the requested decision (including subdecisions) and pre-fetches or not data for decisions further in the decision tree based on configuration. For example, responsive to a request for a preapproval_leasing_decision, the decision engine walks the tree comprising nodes 1410, 1412, 1414 and 1416 and determines the data sources required for each node. Responsive to a request for a finalized_lease_decision, the decision engine walks the tree comprising nodes 1402, 1410, 1412, 1414 and 1416 and determines the data sources required for each node. Determining the data sources required for a node can include communicating with a prediction service (e.g., data modelling and prediction service 140, 240, 340) to determine the data sources required for the prediction models referenced by the decision corresponding to the node. In one embodiment, the decision engine fetches all the data sources needed to execute a requested decision, including the data sources required to execute sub-decisions, before proceeding to processing the decision rules. In another embodiment, the decision engine can be configured to wait to fetch a data source until executing a subdecision or requesting a prediction that uses the data source.

When executing rules to service a decision request, the decision engine processes the rules in order, branching to a subdecision when referenced in a rule. For example, responsive to a request for a preapproval decision, the decision engine may traverse the tree beginning at node 1402. Based on the order of statements in decision 500, the decision engine will execute rule 520 and if rule 520 is true, move to rule 524. At rule 524, the decision engine will branch to fraud_decision 600 (move to node 1412). If the fraud_decision 600 results in a failure code, the decision engine may return the appropriate decline codes and terminate the process. In this configuration and example, the decision engine will not reach affordability_decision and, therefore, will not fetch the data sources referenced by the prediction model prediction-service-us-income-2p0p0. If the fraud_decision results in a pass, the decision engine moves on to node 1414 and so on.

It can be noted from the foregoing that the order of statements in a decision can control when the decision engine requests a data source. For example, because preapproval_leasing_decision 500 references the data sources before referencing the sub-decisions, the decision engine will request the instances of the data sources before executing the sub-decisions. It can be further noted that the decisions can be configured so that decision engine waits to pull certain data until decisions in the decision tree have been passed. For example, because final decision rules 900 references the subdecision rules 500 before the data source CreditReportHard version 1.1, the decision engine will wait for decision rules 500 to be fully executed on a set of decision input data before requesting an instance of CreditReportHard version 1.1 for the consumer. In yet another embodiment, data may be pulled based on the amount of time it takes to pull certain types of data.

Furthermore, the data sources, prediction results, and other information loaded at one level of the tree may be available to subdecisions further down the tree. For example, data sources referenced in decision rules 500 may be implicitly available to sub-decisions. The subdecisions may or may not reference the data sources again. By selecting the order of statements in a decision and the arrangement of decisions in a decision tree, the decision engine can be configured to wait to pull certain data.

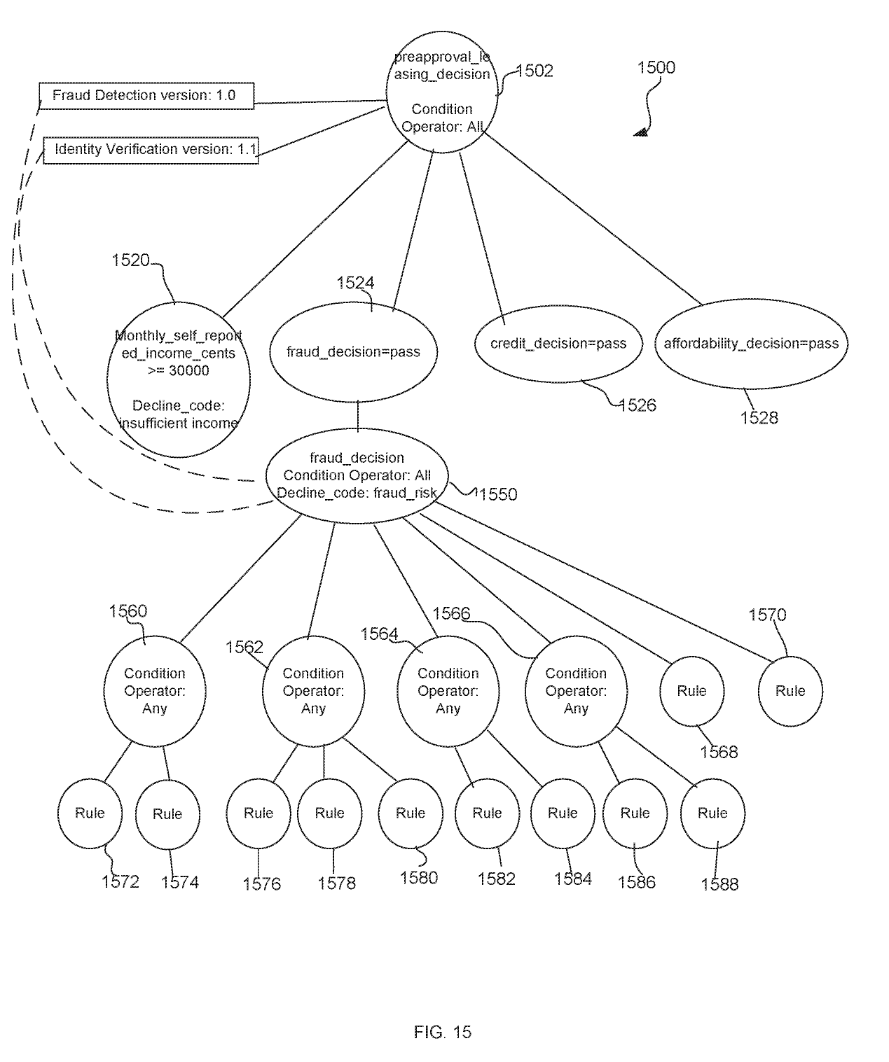

While FIG. 14 illustrates a node for each decision, one of ordinary skill in the art will appreciate that various rules can be represented by child nodes of a decision. FIG. 15 illustrates one embodiment of a tree 1500 for a preapproval_leasing_decision 500 and fraud_decision 600 in more detail.

Node 1502 represents decision rules 500 and specifies the data sources, predictions, constants, failure codes, the top level condition operator 516 and other data declared for decision rules 500. Nodes 1524 represent each condition or condition set to which the operator in the next higher level in the tree applies. For example, node 1520 represents rule 520, node 1524 represents rule 524, node 1526 represents rule 526 and node 1528 represents rule 528.

Because rule 524 depends on a subdecision, the decision engine can create a node 1550 that is a subnode of node 1524, where node 1550 represents decision 600 and specifies the data sources, predictions, constants, failure codes, the top level condition operator 602, top level failure code 602 and other data declared for decision rules 600. A node for each child condition or condition set to which operator 602 applies is created as a child of node 1550. Here node 1560 represents condition set 610, node 1562 represents condition set 612, node 1564 represents condition set 614, node 1566 represents condition set 616, node 1568 represents rule 618 and node 1570 represents rule 620. While not shown, the graph will further include subnodes for decision rules 700 and 800. Each rule node may specify the source of data needed to resolve that node; that is, each rule node may specify the data to which the rule applies. A decision rule node may also specify, for example, a logical operator and values used in the rule.

As can be seen from FIG. 15 (and FIG. 14) a decision tree data structure may include multiple paths, each path containing nodes that represent decisions, including decision rules. The decision tree data structure further represents relationships between decisions, data from data providers (e.g., data sources and predictions), subdecisions and rules. The decision tree data structure defines the sources of data, variables and models to be loaded, constants to be set and outputs for each level of the tree.

In response to a request for a preapproval_leasing_decision, the decision engine can walk the tree and determine all the data sources and predictions referenced. The decision engine can further call to the prediction service to determine any data sources required for a referenced prediction.

The decision engine executes the decision beginning at node 1502. The decision engine pulls the data sources referenced in node 1502 and moves to the first rules branch and leaf node 1520 to execute rule 520. If executing rule 520 results in a false, the result of node 520 is set to insufficient_income and, due to the condition operator, the result of node 1502 is set to insufficient_income. The decision engine returns the decline code to the requesting service and the processing ends.

If the result of executing rule 520 is true, decision engine sets the result of node 1520 to pass and returns to node 1502. The decision engine determines if there is an unprocessed branch below node 1502 and, if so, moves to that branch. In the embodiment illustrated, the decision engine moves to the next rule branch and to node 1524. Because node 1524 references a sub-decision, the decision engine moves to node 1550. Because the data sources specified for node 1550 were already referenced by node 1502 and pulled for the decision request, the decision engine does not re-pull the instances of the data sources (unless an operation in an ancestor decision or the subdecision requires re-pulling the data source instance).

Processing proceeds to the first rules branch under node 1550. The decision engine moves to leaf node 1572 and executes the first rule of decision set 610. If executing the first rule of condition set 610 results in a true, the decision engine sets the result of node 1572 to pass and returns to node 1560. Due to the “any” operator of node 1560, the result of node 1560 is set to pass. In such a circumstance, the decision engine can skip node 1574 and move back to node 1550.

If executing the first rule of decision set 610 results in false the decision engine can set the result of node 1572 to false and return to node 1560. The decision engine determines if there are any additional rules branches under node 1560 and, if so, processing proceeds to the next rules branch under node 1560. In this example, the decision engine moves to node 1574 to execute the second rule of condition set 610.

If executing the second rule of condition set 610 results in a true, the decision engine sets the result of node 1574 to pass and returns to node 1560. Due to the “any” operator of node 1560, the result of node 1560 is set to pass. The decision engine moves back to node 1550.

If executing the second rule of decision set 610 results in false, the decision engine can set the result of node 1574 to false and return to node 1560. The decision engine determines if there any unprocessed branches under node 1560. In this example, since all the branches under node 1560 have been processed and all the results of the children nodes are false, the decision engine can set the result of node 1560 to false. If the result of node 1560 is false, the decision engine can return to node 1550 and set the result to “fraud_risk”. The decision engine can further return to node 1524 and set the result to “fraud_risk”. The decision engine can return to node 1502 and set the result to fraud_risk. Because the result of the node for the requested decision is “fraud_risk,” the decision engine can return the fraud_risk decline code to the requesting service.

Returning to node 1560, if the result of node 1560 is pass, the decision engine can return to node 1550 and, due to the assigned “any” condition operator, determine if there are unprocessed branches below node 1550. If so, the decision engine can move to the next branch (e.g., move to node 1562). Processing can continue with the decision engine traversing the tree until the requested decision results in a pass or a decline code.

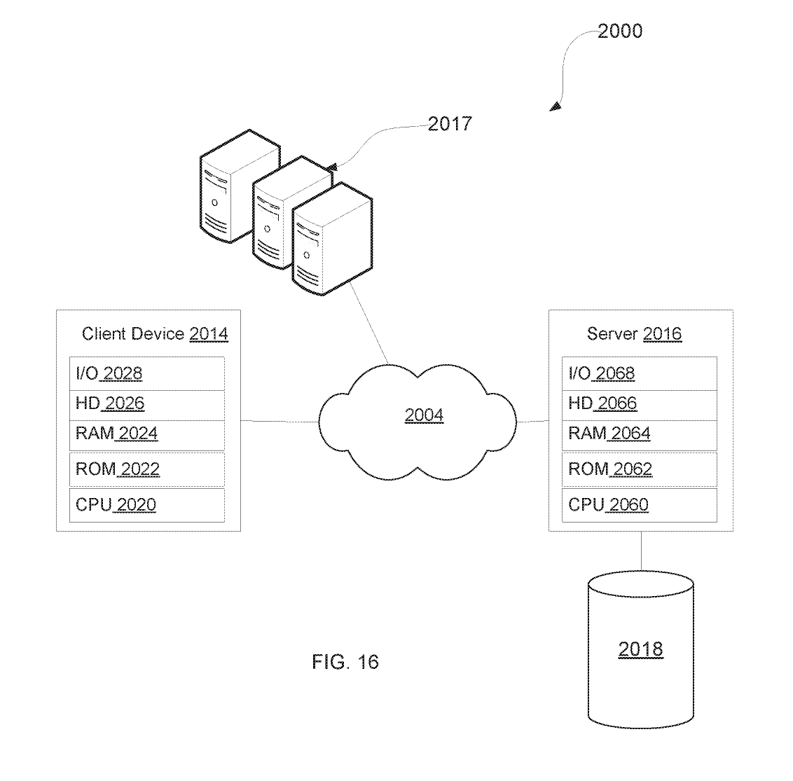

FIG. 16 depicts a diagrammatic representation of a distributed network computing environment where embodiments disclosed can be implemented. In the example illustrated, network computing environment 2000 includes network 2004 that can be bi-directionally coupled to a client computing device 2014, a server system 2016 and one or more information provider systems 2017. Server system 2016 can be bi-directionally coupled to data store 2018. Network 2004 may represent a combination of wired and wireless networks that network computing environment 2000 may utilize for various types of network communications known to those skilled in the art.

For the purpose of illustration, a single system is shown for each of client computing device 2014 and server system 2016. However, a plurality of computers may be interconnected to each other over network 2004. For example, a plurality client computing devices 2014 and server systems 2016 may be coupled to network 2004.

Client computer device 2014 can include central processing unit (“CPU”) 2020, read-only memory (“ROM”) 2022, random access memory (“RAM”) 2024, hard drive (“HD”) or storage memory 2026, and input/output device(s) (“I/O”) 2028. I/O 2028 can include a keyboard, monitor, printer, electronic pointing device (e.g., mouse, trackball, stylus, etc.), or the like. In one embodiment I/O 2028 comprises a touch screen interface and a virtual keyboard. Client computer device 2014 may implement software instructions to provide a client application configured to communicate with an automotive data processing system. Likewise, server system 2016 may include CPU 2060, ROM 2062, RAM 2064, HD 2066, and I/O 2068. Server system 2016 may implement software instructions to implement a decision system (e.g., decision system 110, 200, 300). The decision system may utilize data stored in data store 2018 and obtain data from third party systems 2017. Many other alternative configurations are possible and known to skilled artisans.

Each of the computers in FIG. 16 may have more than one CPU, ROM, RAM, HD, I/O, or other hardware components. For the sake of brevity, each computer is illustrated as having one of each of the hardware components, even if more than one is used. Each of computers 2014 and 2016 is an example of a data processing system. ROM 2022 and 2062; RAM 2024 and 2064; HD 2026, and 2066; and data store 2018 can include media that can be read by CPU 2020 or 2060. Therefore, these types of memories include non-transitory computer-readable storage media. These memories may be internal or external to computers 2014 or 2016.

Portions of the methods described herein may be implemented in suitable software code that may reside within ROM 2022 or 2062; RAM 2024 or 2064; or HD 2026 or 2066. The instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A decision system comprising:
a data store storing a set of decisions;
a processor;
a non-transitory computer readable storage medium storing computer code executable by the processor to, in a runtime environment:
receive, from a first service in the runtime environment, a decision request that references a decision from the set of decisions, the decision defined separately from the computer code;
receive, from the first service, a decision input for the decision request;
generate a decision tree data structure from the set of decisions, the decision tree data structure including a plurality of nodes that represent decisions in the set of decisions, data sources referenced by the decisions, and decision rules that specify conditions on data, and the decision tree data structure further representing relationships between the decisions, data sources and decision rules;
traverse the decision tree data structure to identify a data source to fetch and decision rules to apply;
request an instance of the identified data source from a second service;
determine if a set of data meets a set of conditions specified in the identified decision rules, wherein the set of data comprises data from the instance of the data source;
based on a determination that the set of data meet the set of conditions, return to the first service a decision result that includes an indication that the decision input passed the referenced decision; and
based on a determination that the set of data do not meet the set of conditions, return to the first service a decision result that comprises a failure code.

2. The decision system of claim 1, wherein the decision tree data structure comprises a plurality of levels and defines the data sources and variables to be loaded for each level.

3. The decision system of claim 1, wherein the decision tree data structure further represents prediction models.

4. The decision system of claim 3, wherein the decision tree data structure comprises a plurality of levels and defines the data sources, variables and prediction models to be loaded for each level.

5. The decision system of claim 1, wherein the computer code is further executable to use the decision tree data structure to control prefetching of instances of the data sources.

6. The decision system of claim 1, wherein the decision tree data structure comprises a plurality of paths from a decision node representing the decision to leaf nodes of the decision tree data structure, each path including at least one failure code.

7. The decision system of claim 1, wherein the instance of the data source comprises data from a remote information provider system.

8. The decision system of claim 1, wherein the computer code is further executable to:
cross reference arguments required for fetching an instance of said data source with a first set of decision input attributes; and
based on a determination that decision the first set of decision input attributes do not contain the required arguments, request additional decision input attributes from the decision requestor.

9. The decision system of claim 8, wherein the decision tree data structure comprises a node representing the data source and includes an attribute schema defining the arguments required to fetch the instance of the data source.

10. The decision system of claim 1, wherein the computer code is executable to traverse the decision tree data structure beginning at a node representing the decision through n number of levels of decisions.

11. The decision system of claim 1, wherein the computer code is further executable to pre-fetch the instance of the data source for a subdecision of the decision based on a reference to the data source higher in the decision tree data structure than a node that represents the subdecision.

12. A computer program product comprising a non-transitory computer readable medium storing computer code that is executable by a processor to, in a runtime environment:
receive, from a first service in the runtime environment, a decision request that references a decision from a set of decisions defined separately from the computer code;
receive, from the first service, a decision input for the decision request;
generate a decision tree data structure from the set of decisions, the decision tree data structure including a plurality of nodes that represent decisions in the set of decisions, data sources referenced by the decisions, and decision rules that specify conditions on data, and the decision tree data structure further representing relationships between the decisions, data sources and decision rules;
traverse the decision tree data structure to identify a data source to fetch and decision rules to apply;
request an instance of the identified data source from a second service;
determine if a set of data meets a set of conditions specified in the identified decision rules, wherein the set of data comprises data from the instance of the data source;
based on a determination that the set of data meets the set of conditions, return to the first service a decision result that includes an indication that the decision input passed the referenced decision; and
based on a determination that the set of data does not meet the set of conditions, return to the first service a decision result that comprises a failure code.

13. The computer program product of claim 12, wherein the decision tree data structure comprises a plurality of levels and defines the data sources and variables to be loaded for each level.

14. The computer program product of claim 12, wherein the decision tree data structure further represents prediction models.

15. The computer program product of claim 14, wherein the decision tree data structure comprises a plurality of levels and defines the data sources, variables and prediction models to be loaded for each level.

16. The computer program product of claim 12, wherein the computer code is further executable to use the decision tree data structure to control prefetching of instances of the data sources.

17. The computer program product of claim 12, wherein the decision tree data structure comprises a plurality of paths from a decision node representing the decision to leaf nodes of the decision tree data structure, each path including at least one failure code.

18. The computer program product of claim 12, wherein the instance of the data source comprises data from a remote information provider system.

19. The computer program product of claim 12, wherein the computer code is further executable to:
cross reference arguments required for fetching an instance of said data source with a first set of decision input attributes; and
based on a determination that decision the first set of decision input attributes do not contain the required arguments, request additional decision input attributes from the decision requestor.

20. The computer program product of claim 19, wherein the decision tree data structure comprises a node representing the data source and includes an attribute schema defining the arguments required to fetch the instance of the data source.

21. The computer program product of claim 12, wherein the computer code is executable to traverse the decision tree data structure beginning at a node representing the decision through n number of levels of decisions.

22. The computer program product of claim 12, wherein the computer code is further executable to pre-fetch the instance of the data source for a subdecision of the decision based on a reference to the data source higher in the decision tree data structure than a node that represents the subdecision.
